(19) United States
(12) Patent Application Publication
(10) Pub. No.: US 2005/0271211 A1
(43) Pub. Date: Dec. 8, 2005

(54) Key management system and playback apparatus

(76) Inventor: Itaru Takemura, Saitama (JP)

Correspondence Address: YOUNG & THOMPSON, 745 SOUTH 23RD STREET, 2ND FLOOR, ARLINGTON, VA, 22202, US

(21) Appl. No.: 11/131,381

(22) Filed: May 18, 2005

(30) Foreign Application Priority Data
May 18, 2004 (JP) 2004-147992

(51) Int. Cl. H04L 9/00

(52) U.S. Cl. 380/277

(57) ABSTRACT

The Information providing system includes a key management center, information transmitter and information receiver. The key management center assigns, to the receivers, confidential information and public information for decrypting the encrypted information transmitted by the information transmitter. The key management center determines the set of the receivers for which decryption of the encrypted information is not permitted, generates key information that can be decrypted only by the receivers other than the set, and transmits the key information with the information encryption key for encrypting the transmission information to the information receivers. The information transmitter encrypts the transmission information with the information encryption key of the transmission information to produce the encrypted information, and transmits it to the information receivers with the key information.

### BACKGROUND OF THE INVENTION

1. Field of the Invention

This invention relates to a key management system using a tree structure and having a function of revoking a specific receiver.

2. Description of Related Art

In order to protect copyright of contents being literary works such as a movie and music, it is broadly carried out that contents are provided after being encrypted. In an example of such a system, plural decryption keys (i.e., device keys) or confidential information for generating decryption keys are given to a receiver or a playback apparatus (hereinafter referred to as “information receiver” or “receiver”). On the other hand, the encrypted contents and the key information, by which only a playback apparatus permitted to play back the contents can generate a decryption key of the contents, are transmitted via a network or supplied to the information receiver in a manner recorded on a recording medium. The receiver and the playback apparatus permitted to play back the contents generate the decryption key of the contents from its own confidential information and the key information thus received, and decrypts the contents by using the decryption key to play back them. On the contrary, since a receiver or a playback apparatus which is not permitted to play back the contents (revoked) cannot generate the decryption key of the contents, it cannot play back the encrypted contents.

Supposing a general equipment as a receiving apparatus or a playback apparatus, it is not very favorable that the apparatus has the function of altering its own confidential information because the manufacturing cost of the apparatus increases and the security of storing the confidential information may be deteriorated. Therefore, a system is desired which meets a receiving apparatus or a playback apparatus which does not have the function of altering the decryption key. If the receiving apparatus or the playback apparatus has the function of altering the decryption key, the apparatus can use the decryption key obtained at a certain point of time to obtain the key information transmitted thereafter, and hence the communication amount can be reduced. However, the apparatus which does not have the function of altering the decryption key only possesses the decryption key given at an initial time (e.g., at the time the apparatus is manufactured). Therefore, when the information transmitter (sender) transmits the key generation information, it must transmit, every time, information by which the apparatus can obtain the decryption key of the contents by using only that decryption key.

In such a system, there is proposed a key management system using a tree structure as a technique of managing key information. As examples thereof, there are known “The Complete Subtree Method”, “The Subset Difference Method” (see. Document-1: DalitNaor, NoniNaor and Heff Lotspiech, “Revocation and Tracing Schemes for Stateless Receivers”, Lecture Notes in Computer Science, Vol. 2139, pp. 41-62, 2001, for example), “Three Pattern Division Method” and the like. In these systems, when the key generation information for generating the decryption key of the contents is illegally disclosed or leaked, a process of revoking the key generation information is possible.

There are four performances of the key management system using the tree structure as follows:
(1) Amount of key information to be transmitted
(2) Amount of confidential information owned by the receiver
(3) Amount of public information owned by the receiver
(4) Amount of calculation for calculating the decryption keys from the confidential information and the public information

In the Complete Sub-tree Method mentioned above, (2) Amount of confidential information owned by the receiver is small, but (1) Amount of key information to be transmitted is large. In the Subset Difference Method, (1) Amount of key information to be transmitted is small, but (2) Amount of confidential information owned by the receiver is large. On the other hand, the Three Pattern Division Method has an intermediate characteristic of them.

Incidentally, there is known a key management system in which prime numbers are assigned to the receivers as public information and the receivers generate the plural decryption keys from the confidential information thus given and the public information (“Master Key Method”, see. Document-2: Tomoyuki Asano, “A revocation scheme with minimal storage at receivers”, Lecture Notes in Computer Science, Vol. 2501, pp 433-450, 2002”). When this method is used, only one confidential information is given to the receiver and the receiver can obtain the decryption keys from the public information and the confidential information thus given. Hence, (1) Amount of key information to be transmitted and (2) Amount of confidential information owned by the receiver can be smaller than those in the case of using the Complete Sub-tree Method. However, since a lot of prime numbers are needed as the public information, (3) Amount of public information owned by the receiver and (4) Amount of calculation for calculating the decryption keys from the confidential information and the public information increase.

### SUMMARY OF THE INVENTION

The above may be cited as an example of a problem to be solved by the invention. The present invention provides a key management system using tree structure capable of reducing the amount of key information to be transmitted to the receiver, the amount of confidential information stored in the receiver and the amount of public information stored in the receiver, and a playback apparatus capable of decrypting the key which is encrypted by the above key management system.

As a best mode to implement the present invention, the description will be given of a key management apparatus, a playback apparatus, a recording medium, a key management system, a key management method, a key management program, a playback method and a playback program.

The above key management system aim to protect copyrights of the contents, and adopts the key management system using tree structure as a technique of managing the key information. An information providing system employing this key management system is constructed by a key management center such as a key management apparatus, an information transmitter (sender) and an information receiver. The key management center assigns confidential information and public information to decrypt the encrypted information transmitted by the information transmitter (e.g., a “recording apparatus” which records contents on a “recording medium”) to each of the information receivers (e.g., a “playback apparatus” which plays back the contents recorded on the “recording medium”). The key management center determines the set of the receivers for which the decryption of the encrypted information becomes impossible, and generates the key information by which the receivers other than the set can decrypt the encrypted information. The key management center also delivers the key information to the information transmitter together with the information encryption key used to encrypt the transmission information.

The information transmitter encrypts the transmission information by using the information encryption key of the transmission information delivered from the key management center to produce the encrypted information, and transmits the encrypted information to the receiver together with the key information. The receiver who is not revoked (hereinafter also referred to as “non-revoked receiver”) receives the encrypted information, calculates the information decryption key from the confidential information and the public information owned by the receiver and the key information thus received, and decrypts the received information from the encrypted information by using the information decryption key. Here, the information encryption key and the information decryption key (hereinafter referred to as “session key”) are calculated by using the encryption/decryption key determined according to the master key.

In the above key management system, the encryption/decryption keys are assigned to the subsets defined to the nodes constituting the tree structure. The encryption/decryption key can be derived by using the master key assigned to each node. The master key to be assigned to the node in the lower layer is generated based on the master key assigned to the node in the upper layer. Thus, it is sufficient that the information receiver owns one master key as the confidential information and common information as the public information, the information that the receiver should own to produce the encryption/decryption keys can be reduced.

A second confidential information operating unit generates master key to be assigned to the child node from the master key assigned to the parent node, in accordance with a bijective function. Preferably, Pseudo Random Permutation (PRP) may be used as the bijective function. In this case, the encryption/decryption keys assigned to the subsets defined to the nodes of the parent-child relationship have uncorrelated relationship. Therefore, the copyright of the contents can be safely protected.

According to the embodiment of the key management method and key management program, the same advantages as the above-mentioned embodiment of the key management apparatus can be obtained. Similarly, according to the embodiments of the playback method and the playback program, the same advantages as the above-mentioned embodiment of the key management apparatus can be obtained.

The nature, utility, and further features of this invention will be more clearly apparent from the following detailed description with respect to preferred embodiment of the invention when read in conjunction with the accompanying drawings briefly described below.

### BRIEF DESCRIPTION OF THE DRAWINGS

FIG. 1 is a diagram showing an example of an information providing system to which a key management system is applied;

FIG. 2 is a diagram showing another example of an information providing system to which a key management system is applied;

FIG. 3 is a diagram showing still another example of an information providing system to which a key management system is applied;

FIG. 4 is a diagram showing an example of a tree structure used for the key management system;

FIG. 5 shows examples of encryption/decryption keys assigned to the nodes in a key management system according to a first basic method;

FIG. 6 shows a method of dividing a set N\R of receivers in the key management system;

FIG. 7 shows examples of encryption/decryption keys assigned to nodes in a key management system according to a second basic method;

FIG. 8 shows a method of calculating encryption/decryption keys of receivers in a key management system according to the second basic method;

FIG. 9 shows examples of encryption/decryption keys assigned to the nodes in a key management system according to a first embodiment of the invention;

FIG. 10 shows other examples of encryption/decryption keys assigned to the nodes in a key management system according to a first embodiment of the invention;

FIG. 11 is a diagram showing a method of calculating encryption/decryption keys of receivers in a key management system according to the first embodiment of the invention;

FIG. 12 is a table showing comparison of performances by key management systems;

FIG. 13 is a diagram for explaining an outline of a key management system according to a second embodiment of the invention;

FIG. 14 is a diagram showing an information providing system to which the key management system according to the present invention is applied;

FIG. 15 is a block diagram showing a construction of a contents recording system according to an embodiment of the invention;

FIGS. 16(a) to 16(e) show contents of signals in the respective parts in the contents recording system shown in FIG. 15;

FIGS. 17(a) and 17(b) show contents of signals in the respective parts in the contents recording system shown in FIG. 15;

FIG. 18 is a block diagram showing a construction of a contents playback system according to an embodiment of the invention;

FIGS. 19(a) and 19(b) show contents of signals in the respective parts in the contents playback system shown in FIG. 18i;

FIGS. 20(a) to 20(d) show contents of signals in the respective parts in the contents playback system shown in FIG. 18;

FIG. 21 is a flowchart showing a key information generation process;

FIG. 22 is a flowchart showing a process of assigning encryption keys to subsets;

FIG. 23 is a flowchart showing a process of assigning encryption keys to subsets;

FIG. 24 is a flowchart showing an encryption process of contents;

FIG. 25 is a flowchart showing a decryption process of contents;

FIG. 26 is a flowchart showing a process relating to calculation of decryption keys in a case of using a key management system according to the first embodiment;

FIG. 27 is a flowchart showing a process relating to calculation of decryption keys in a case of using a key management system according to the second embodiment; and

FIG. 28 is a flowchart showing a process relating to calculation of decryption keys in a case of using a key management system according to the second embodiment.

### DETAILED DESCRIPTION OF THE PREFERRED EMBODIMENTS

The preferred embodiments of the present invention will now be described below with reference to the attached drawings. First of all, a basic explanation is given as to a key management system, and then a key management system according to the embodiments of the present invention will be described.

(1.1) Key Management System with Receiver Revocation Function

In a system in which a transmitter or sender transmits identical data to a large number of receivers, there is a method in which a reliable key management center distributes confidential information to decrypt the transmitted information to all the receivers in advance, and the sender encrypts and transmits the information to the receivers so that the receivers who does not have the confidential information cannot decrypt the transmitted information. In this case, there is such a problem that, if all the receivers have the identical confidential information, once a malicious receiver publishes its confidential information, it becomes possible for any person to decrypt the information transmitted thereafter.

As a countermeasure to this problem, there is a method, i.e., a key management system having receiver revoking function, which disables the decryption of the transmitted information by using leaked confidential information when the key management center distributes different confidential information to the receivers and the confidential information of a certain receiver is leaked out. This invention deals with such a key management system.

Here, it is assumed such an application that the confidential information owned by the receivers can never be altered except for the initial assignment of the confidential information (decryption key, etc.) to the receivers.

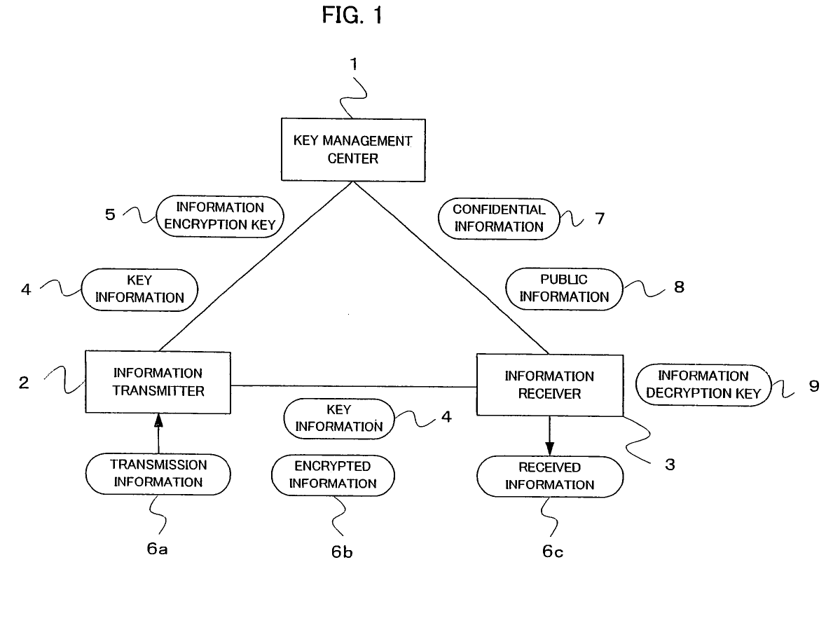

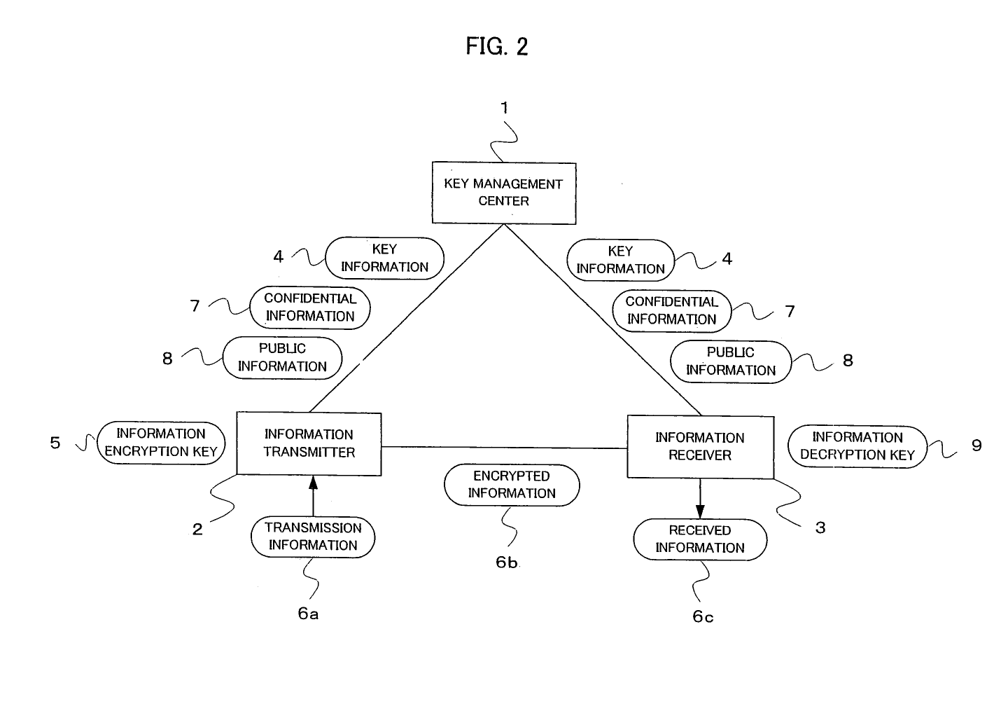

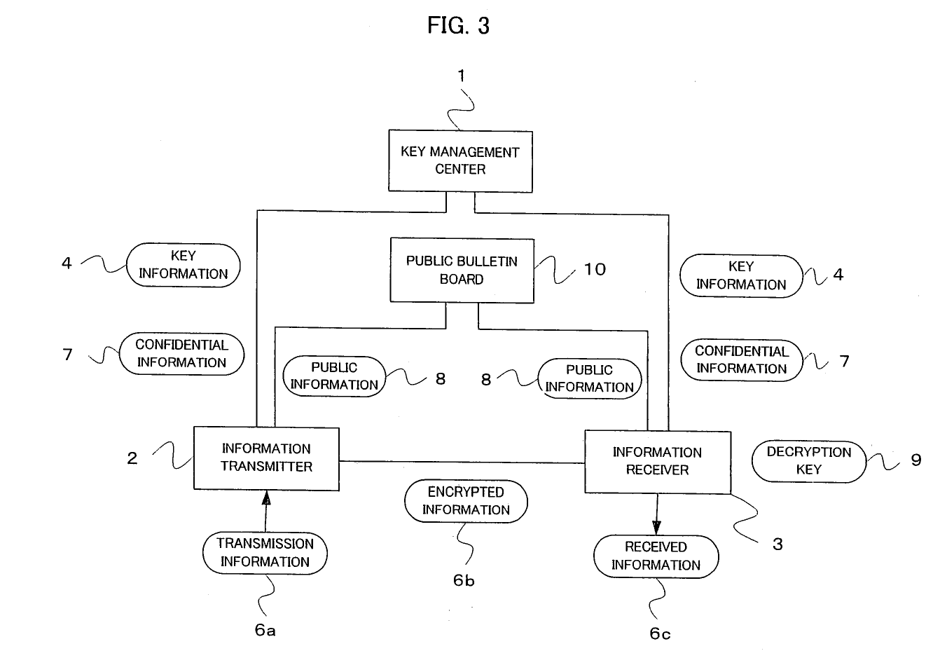

A model of an information providing system, to which the key management system having the receiver revoking function is applied, is shown in FIGS. 1 to 3. In FIGS. 1 and 2, the information providing system includes three constitutive elements, i.e., a key management center 1, an information transmitter 2 and an information receiver 3. On the other hand, the information providing system shown in FIG. 3 includes four constitutive elements, i.e., a key management center 1, an information transmitter 2, an information receiver 3 and a public bulletin board 10. The description will be given from FIG. 1 in order.

In FIG. 1, the key management center 1 assigns, to each information receiver 3, confidential information 7 and public information 8 for decrypting encrypted information 6b transmitted by the information transmitter 2. The public information 8 does not exist in a certain key management system, but the confidential information 7 necessarily exists. Also, the key management center 1 determines a set of receivers for which the decryption of the encrypted information 6b is disabled, generates key information 4 which the receivers other than the receivers belonging to the above set can decrypt, and transmits the key information 4 to the information transmitter 2 together with the key (information encrypting key 5) for encrypting the transmission information 6a. Hereinafter, disabling a certain receiver to decrypt the transmitted information is called “revocation of receiver”. It is assumed here that the generation, storage and transmission of the confidential information 7 assigned to the respective receivers and the key (information encrypting key 5) used to encrypt the transmission information 6a are performed safely.

The information transmitter 2 encrypts the transmission information 6a by using the information encryption key 5 transmitted from the key management center 1 to produce the encrypted information 6b, and transmits the encrypted information 6b to the receivers together with the key information 4 which can be decrypted only by the receivers who are not revoked (hereinafter referred to as “non-revoked receiver”).

When receiving the encrypted information 6b, the non-revoked receiver calculates the information decryption key 9 by using the confidential information 7 and the public information 8 that the receiver owns and the received key information 4, and decrypts the encrypted information 6b by using the information decryption key 9 to obtain the received information 6c. On the contrary, the receiver who is revoked (hereinafter referred to as “revoked receiver”) cannot obtain any information associated with the encrypted information 6b if plural revoked receivers collude with each other. Here, it is assumed that a large number of receivers exist.

In the information providing system shown in FIG. 2, the key management center 1 transmits only the key information 4 to the information transmitter 2, and does not transmit the information encryption key 5. In this case, like the information receiver 3, the information transmitter 2 calculates the information encryption key 5 from the confidential information 7 and the public information 8 received from the key management center 1. Therefore, the key management center 1 needs to assign the confidential information 7 and the public information 8 to the information transmitter 2.

In the information transmission system shown in FIG. 3, the public information B is not stored by the key management center 1, but stored in a public space such as a public bulletin board 10. Every time the information is encrypted or decrypted, the information transmitter 2 or the information receiver 3 accesses the public bulletin board 10 to download the public information 8.

Next, the constitutive elements described above will be described in detail.

It is assumed that N is a set of all receivers, and the number of its elements is |N|=N. It is also assumed that a subset R of N is a set of the receivers to be revoked, and the number of its elements is |RI |=r. The goal of the key management system having the receiver revoking function is that the receivers permitted by the key management center (or the information transmitter), i.e., all the receivers uεN\R who are not included in R can decrypt the transmitted information, and all the receivers included in R who are not permitted can obtain no transmitted information even if they collude with each other.

(a) Key Management Center

(i) Initial Setting

First, subsets S₁, S₂, . . . , S_{w}(^{∀}ⱼ,Sⱼ⊂N) of the set N of all the receiver are defined. Each subset Sⱼ is assigned encryption (decryption) key Lⱼ. It is desired that each Lⱼ is assigned a uniformly distributed value independent of each other. To each of the receivers (the receiving apparatuses) u, confidential information SIᵤ and public information PIᵤ are assigned. It is necessary that the confidential information SIᵤ and the public information PIᵤ are assigned such that all the receivers uεSⱼ included in Sⱼ can obtain the decryption key Lⱼ assigned to the subset Sⱼ to which it belongs, from the confidential information SIᵤ and the public information PIᵤ assigned to itself. In addition, the confidential information SIᵤ and the public information PIᵤ must be assigned such that all the receivers uεN\Sⱼ who are not included in Sⱼ cannot obtain the decryption key Lⱼ even if they collude with each other.

(ii) Generating Key Information

(1) The key K used to encrypt and decrypt transmission information M (i.e., the above-mentioned information encryption key 5 or information decryption key 9, hereinafter referred to as “session key”) is selected.

(2) The receivers uεN\R belonging to the complementary set N\R of the subset R are divided into some subsets Sᵢ₁, Sᵢ₂, . . . Sᵢₘ.

$$\underline{N} / \underline{R} = {⋃}_{i = 1}^{m} {\underline{S}}_{{i}_{j}} \qquad ( 1 \text{-} 1 )$$

It is assumed that the encryption/decryption keys assigned to the above subsets by the initial setting are Lᵢ₁, Lᵢ₂, . . . Lᵢₘ. Since Lᵢ₁, Lᵢ₂, . . . Lᵢₘ are the encryption keys for the information transmitter 2 to encrypt the session key, and are the decryption keys for the information receiver 3 to decrypt the session key, they are expressed as “encryption/decryption key” if they includes the meanings of both the encryption key and the decryption key.

(3) The session key K is encrypted m times by using the encryption/decryption keys Lᵢ₁, Lᵢ₂, . . . Lᵢₘ and the following equation (1-2) is generated.
[i₁,i₂, . . . iₘ,E_{enc}(K,Lᵢ_{₁}),E_{enc}(K,Lᵢ_{₂}), . . . ,E_{enc}(K,Lᵢ_{ₘ})] (1-2)
The equation (1-2) is delivered to the information transmitter 2 together with the session key K. Here, i₁, i₂, . . . iₘ are index information by which each receiver uⱼ specifies the cipher text E_{enc}(K,Lᵢⱼ) assigned to itself from the equation (1-2).

We assume that the delivery of the session key K to the information transmitter is securely carried out. Note that E_{enc} indicates the encryption algorithm. There are following two encryption, decryption algorithms used in this system (note that the completely same algorithm may be used as those two algorithms).

Encryption Algorithm F_{enc} and Decryption Algorithm F_{dec} of the Transmission Information M

Cipher text C_{K}=F_{enc}(M,K) is generated by using the session key K. Processing speed is required.

Encryption Algorithm E_{enc} and Decryption Algorithm E_{dec} of the Session Key K

They are used for the delivery of the session key. Higher security than F_{enc} is required.

It is noted that, if the session key is not delivered to the information transmitter 2, the confidential information and the public information are assigned to the information transmitter in the initial setting, like the information receiver, to enable the information transmitter to calculate the session key from those information and the key information.

(b) Information Transmitter

The information transmitter receives the session key K and the key information which can be decrypted only by permitted receivers from the key management center, encrypts the transmission information M using the encryption algorithm F_{enc} with the session key K, and transmits the cipher text [symbol]
[i₁,i₂, . . . iₘ,E_{enc}(K,Lᵢ_{₁}),E_{enc}(K,Lᵢ_{₂}), . . . ,E_{enc}(K,Lᵢ_{ₘ})],F_{enc}(M,K) [symbol] (1-3)
The portion in square brackets [ ] in the above equation (1-3) is called “header” of F_{enc}(M,K).

(c) Information Receiver

The information receiver u receives the following cipher text encrypted by the information transmitter. [symbol]
[i₁,i₂, . . . iₘ,C_{L}_{₁},C_{L}_{₂}, . . . ,C_{L}_{ₘ}],C_{K} [symbol] (1-4)
Then, the receiver operates as follows:

(1) Find iⱼ which satisfies uεSᵢⱼ (in case uεR the result is null).

(2) Calculate Lᵢⱼ from the confidential information SIᵤ and the public information PIᵤ that the receiver has.

(3) Calculate K=E_{dec}(Cᵢⱼ, Lᵢⱼ).

(4) Calculate M=F_{dec}(C_{K}, K).

There are following algorithms which can implement the above key management system:
The Complete Sub-tree Method
The Subset Difference Method
Tree Pattern Division Method

The above methods are different in (1) the definition of the subsets S₁, . . . , S_{w} of the receivers, (2) the method of assigning the encryption (decryption) keys L_{Sj} and the public information PI to the subsets, (3) the method of dividing the set N\R of the non-revoked receivers, (4) the method of assigning SIᵤ and PIᵤ to each receiver u, and (5) the method of obtaining the key L_{Sj} assigned to the subset Sⱼ to which the receiver belongs, from SIᵤ and PIᵤ.

Those algorithms are evaluated in view of following four aspects.

Amount of Key Information to be Transmitted

It corresponds to the portion “[ ]” in the equations (1-2) and (1-3), and it is transmission information necessary to decrypt the cipher text F_{enc}(M,K). Generally, it is proportional to the number m of the subsets obtained by dividing N\R.

Amount of Confidential Information SIᵤ that the Receiver Stores.

Namely, how much confidential information such as decryption key and the like does a receiver need to store.

Amount of Public Information PIᵤ that the Receiver Stores.

Namely, how much public information to obtain the decryption key does a receiver need to store.

Amount of Arithmetic Operation Necessary for the Receiver to Decrypt the Transmitted Information

(1.2) First Basic Method

As a first basic method of the embodiment of the invention, the key management system used in the above-mentioned Complete Sub-tree Method, Three Pattern Division and the like will be described.

(1.2.1) Definition of Subsets S₁, S₂, . . . , S_{w}

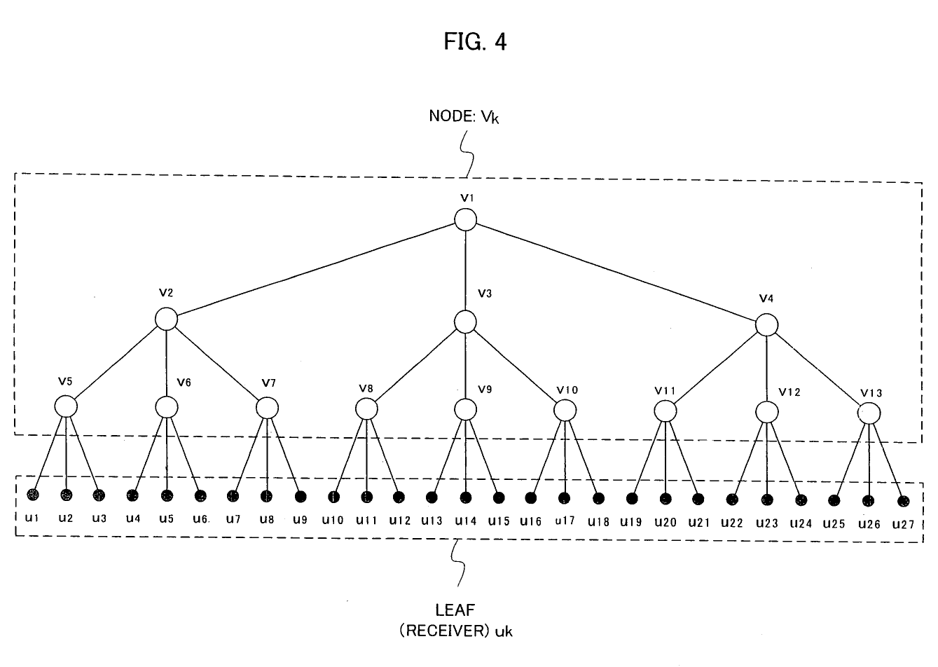

First, the subsets S₁, S₂, . . . , S_{w} of the set N of the whole receivers is defined. To the subsets, the encryption/decryption keys Lᵢ₁, Lᵢ₂, . . . , Lᵢₘ are assigned. Each receiver uⱼ (j=1, 2, . . . N) is assigned to the leaf of a-ary having N leaves (here, “a” satisfies a>1, and N is a power of “a”). FIG. 4 shows an example of the case in which a=3, N=27.

Each internal nodes of the a-ary tree is numbered as vₖ (k=1, 2, . . . , (N−1)/(a−1)). Note that the root is numbered as v₁, and the numbering of the nodes is made in an order from the upper layer to the lower layer, and from the left side to the right side, as shown in FIG. 4. The receivers uⱼ (j=1, 2, . . . , N) assigned to the leaves are also numbered in an order from the left side to the right side.

Next, 2^{a}−2 subsets S_{k,b1b2 . . . bi . . . ba} are defined for all the internal nodes vₖ (k=1, 2, . . . , (N−1)/(a−1)). Here, “bi” satisfies the following equation (2-1).
bᵢε{0,1},Σᵢ₌₁^{a}bᵢ≠0,Σᵢ₌₁^{a}bᵢ≠a (2-1)

The subsets S_{k,b1b2 . . . bi . . . ba} are defined as the set of the receivers assigned to the descendant leaves of the child nodes for which bᵢ=1 if the “a” child nodes of the nodes vₖ are defined as b₁, b₂, . . . , bᵢ, . . . , bₐ in an order from left side to right side. Namely, if a leaf, to which the receiver to be revoked is assigned, exists at the descendant of the “a” child nodes of the node vₖ, bᵢ corresponding to the child node satisfies bᵢ=0. In this case, the child node satisfying bᵢ=0 is called “revoked node”. Whether or not the “a” child nodes of the node vₖ is the revoked node is indicated by the value biε{0,1). Those values arranged from the left side in an order of b₁, b₂, . . . , bᵢ, . . . bₐ is called “node revocation pattern”.

For example, in the case that a=3, N=27 shown in FIG. 4, the subsets defined to the root node v₁ are S_{1,100}, S_{1,010}, S_{1,001}, S_{1,110}, S_{1,101}, S_{1,011}, S_{1,111}, and the subsets defined to the node v₂ . . . v_{(N-1)(a-1)} are S_{k,100}, S_{k,010}, S_{k,001}, S_{k,110}, S_{k,101}, S_{k,011}. At this time, as the set including all the receivers, the set S_{1,11 . . . 1} is defined for the root node of a-ary tree. The subset S_{2,101} is a subset constituted by the receivers u₁, u₂, u₃, u₇, u₈, u₉ assigned to the descendant leaves of the nodes v₅, v₇, corresponding to b₁ and b₃ in child nodes v₅, v₆, v₇, of the node v₂.

(1.2.2) Method of Assigning Encryption/Decryption Keys L_{k,b1b2 . . . ba} to Each Subset S_{k,b1b2 . . . ba}

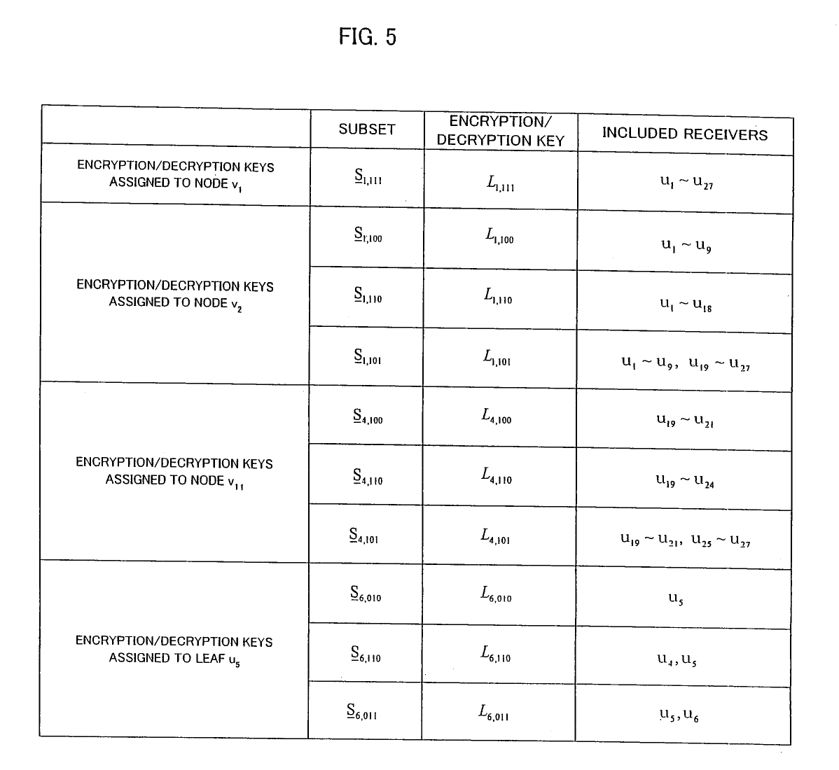

The key management center assigns the encryption/decryption keys L_{k,b1b2 . . . ba}, each having independent values to the subsets S_{k,b1b2 . . . ba}. FIG. 5 shows examples of the subsets, the encryption/decryption keys and the receivers included in the subsets, which are assigned to some nodes and leaves in the case that a=3 and N=27.

(1.2.3) Method of Assigning SIᵤ to Each Receiver u, and Calculation Method of Encryption/Decryption Keys LS_{k,b1b2 . . . ba} from SIᵤ

The key management center directly gives the receiver u, the encryption/decryption keys L_{k,b1b1 . . . ba}, as the confidential information PIᵤ. These keys are assigned to the subsets including the receiver u as its element, in the subsets S_{k,b1b2 . . . ba} defined to the nodes vₖ existing on the path from the leaf to which the receiver u is assigned to the root.
(2^{a-1}−1)logₐN+1 (2-2)
For example, in the case that a=3 and N=27, the description of the confidential information SIᵤ₂₀ owned by the receiver u₂₀ will be given. The subsets in which the receiver u₂₀ is included are S_{1,111}, S_{1,001}, S1,101, S_{1,011}, S4,100, S_{4,110}, S_{4,101}, S_{11,010}, S_{11,010} and S_{11,011}. The confidential information SIᵤ₂₀ corresponding to those subsets are L_{1,111}, L_{1,001}, L_{1,101}, L_{1,011}, L_{4,100}, L_{4,110}, L_{4,101}, L_{11,010}, L_{11,110} and L_{11,011}. These informations (encryption/decryption keys) are stored in the receiver u₂₀.
(1.2.4) Dividing Method of N\R (Set of Non-Revoked Receivers)

This section describes the method that divide the set N\R to the above defined subset. Here, the set N\R includes receivers permitted to receive information (set of non-revoked receivers). First, the key management center sets all the internal nodes, existing on the path from the leaf corresponding to the receiver to be revoked to the root, to the revoked nodes. If there is no receiver to be revoked, the set S_{1,11 . . . 1} is N\R. When the revoked node is vₖ, except for the case that all the child nodes of vₖ are revoked nodes, the subset S_{k,b1b2 . . . ba} (bᵢ satisfies the equation (2-1)) defined to the vₖ is chosen as the subset constituting the set N\R of the receiver. Here, it is necessary that a pattern corresponding to the actual revoked child nodes is chosen as the node revocation pattern b₁b₂ . . . bᵢ . . . bₐ. Thus, one subset is chosen for the above revoked node. The above process is carried out for all the revoked nodes, and the chosen subsets constitute the set N\R. The upper limit of the number of the chosen subsets is given as: r(logₐN/r+1) when the number of the receivers to be revoked is expressed as: |R|=r.

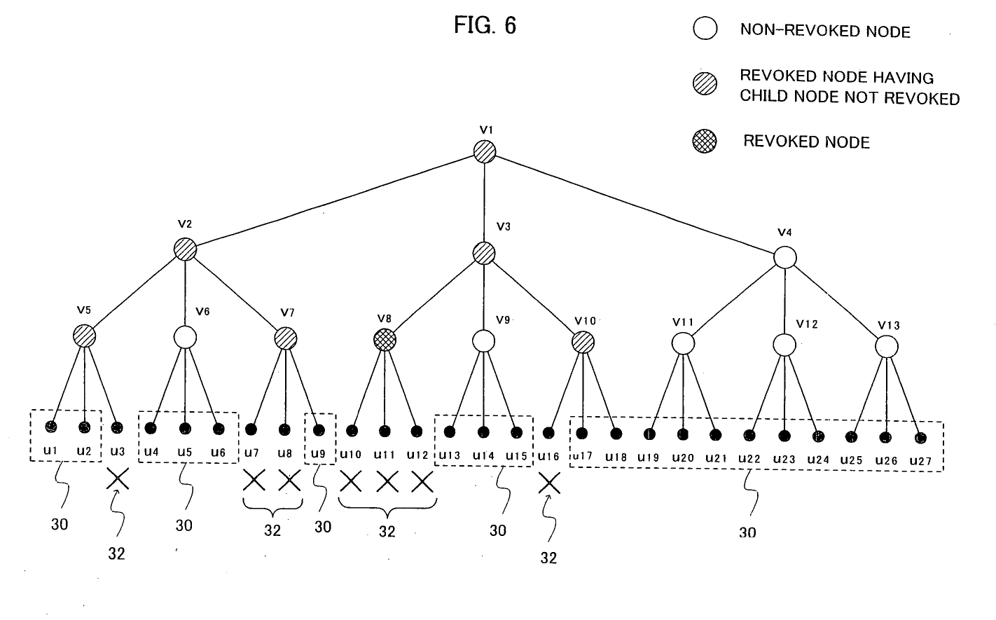

FIG. 6 shows an example in which the receivers 32 to be revoked are u₃, u₇, u₈, u₁₀, u₁₁, u₁₂, u₁₆ (the reference numeral 30 shows the receivers who are not revoked) in the case that a=3 and N=27. In this case, the revoked nodes are v₁, v₂, v₃, v₅, v₇, v₈, v₁₀ and the revoked nodes for which all of the child nodes are not the revoked node are v₁, v₂, v₃, v₅, v₇, v₁₀. Therefore, the subsets constituting N\R are S_{1,001}, S2,010, S_{3,010}, S_{5,110}, S_{7,001}, S_{10,011}.

(1.3) Second Basic Method

Next, as the second basic method of the embodiment of the present invention, the key management system according to the Master Key Method described in the above-mentioned Document-2 will be described.

Since the definition of the subsets S₁, S₂, . . . , S_{w}, and the dividing method of the set N\R are the same as those in the above-described first basic method, and hence the description thereof will be omitted.

(1.3.1) Method of assigning encryption/decryption keys L_{k,b1b2 . . . ba} and public information p_{k,b1b2 . . . ba} to each subset S_{k,b1b2 . . . ba}

The key management center chooses two large prime numbers q₁ and q₂ (e.g., not smaller than 512 bits), and publishes the product M of q₁ and q₂ as the public information. Each of the prime numbers q₁ and q₂ is confidentially stored in the key management center. Next, the key management center chooses the prime numbers p_{k,b1b2 . . . ba}. The number of prime number P_{k,b1b2 . . . ba}, is shown in the following equation (2-3).

$$( {2}^{a} - 2 ) \frac{N - 1}{a - 1} + 1 \qquad ( 2 \text{-} 3 )$$

Here, k=1, 2, . . . , (N−1)/(a−1), bᵢε(0,1}, and “bᵢ” satisfies the equation (2-4) for all “k”:
Σᵢ₌₁^{a}bᵢ≠0 (2-4)
Also, “bᵢ” satisfies the equation (2-5) for k≠1:
Σᵢ₌₁^{a}bᵢ≠a (2-5)
Hereinafter, the indexes b₁b₂ . . . bₐ are expressed as “B”.

The key management center assigns the prime numbers p_{k,B} to the subsets S_{k,B}, and publishes each p_{k,B} and the assignment as the public information PI. Also, “E” is determined as the product of all the prime numbers p_{k,B} assigned to all the subsets S_{k,B}. The key management center chooses gεZ*_{M} at random, and determines the encryption/decryption keys L_{k,B} assigned to the subsets S_{k,B} as the equation (2-6):
L_{k,B}=g^{E/p}^{_{k,B}}modM (2-6)
Here, Z*_{M} is a set of residue class rings Z_{M}={0, 1, . . . , M−1} which has a positive integer M as a modulus and which is relatively prime to M. This is called “irreducible residue class”, and forms group in respect of multiplication. Also, “g” is confidentially stored by the key management center.

The key management center assigns the encryption/decryption keys L_{k,B} satisfying bᵢ=1 to i-th child node from the left side of the child nodes of the node vₖ. Similarly, the key management center assigns the subsets S_{k,B} and the prime numbers p_{k,B} to the child nodes of the node vₖ.

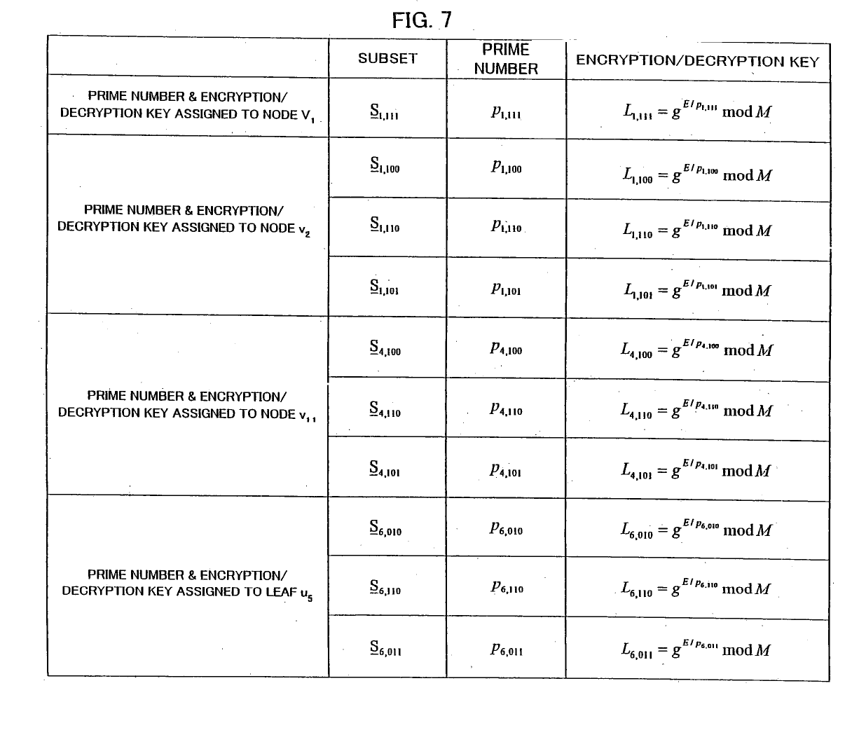

For example, FIG. 7 shows, the subsets, the prime numbers and the encryption/decryption keys assigned to some nodes and leaves in the case that a=3 and N=27.

(1.3.2) Method of Assigning SIᵤ and PIᵤ to Each Receiver u, and Method of Calculation, Encryption/Decryption Keys L_{k,B} from SIᵤ and PIᵤ

The key management center gives the receiver u, as the public information PIᵤ, the prime numbers assigned to the nodes existing on the path from the leaf to which the receiver u is assigned to the root. The number of prime number given to receiver u is shown in the equation (2-2).

Also, the key management center gives the receiver u, as the confidential information SIᵤ, the master keys Mkᵤ corresponding to the encryption/decryption keys assigned to the internal nodes existing on the path from the leaf to which the receiver u is assigned to the root, The number of encryption/decryption keys calculated from the master key Mkᵤ is shown in the equation (2-2). The master keys can be calculated from the equation (2-7):
SIᵤ=MKᵤ=g^{E/P}^{ᵤ}modM (2-7)
Here, “Pᵤ” is a product of all the prime numbers assigned to the nodes existing on the path from the leaf to which the receiver u is assigned to the root.

From the master keys defined by the equation (2-7), the encryption/decryption keys, assigned to the nodes existing on the path from the leaf to which the receiver u is assigned to the root, can be obtained using the public information (prime numbers) owned by itself as shown in the equation (2-8):
L_{k,B}=(MKᵤ)^{P}^{ᵤ}^{/p}^{_{k,B}}modM (2-8)

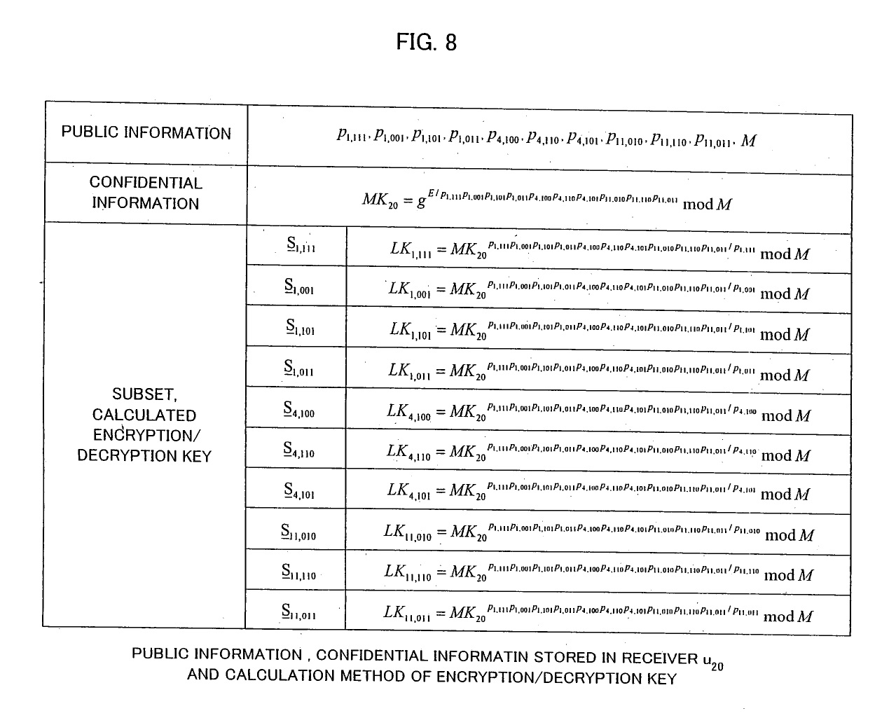

For example, FIG. 8 shows the confidential information SIᵤ₂₀ and the public information stored in the receiver u₂₀, as well as the calculating method of the encryption/decryption keys from them, in the case that a=3 and N=27.

(2.1) Method of First Embodiment

Hereinafter, the key management system according to the first embodiment of the invention, which improves the above-mentioned second basic method (Master Key Method) will be described.

Since the definition of the subsets S₁, S₂, . . . , S_{w} and the dividing method of the set N\R are the same as those in the above-described first and second basic methods, the description thereof will be omitted.

(2.1.1) Method of Assigning Encryption/Decryption Keys L_{k,b1b2 . . . ba} and Public information PI to each Subset S_{k,b1b2 . . . ba}

The key management center chooses two large prime numbers q₁ and q₂ (e.g., not smaller than 512 bits), publishes the product M of q₁ and q₂ as the public information. Each of the prime numbers q₁ and q₂ is confidentially stored in the key management center.

Next, the key management center chooses 2^{a}-2 natural numbers p_{b1b2 . . . ba} (e.g., prime numbers) relatively prime and satisfying the equation (3-1). Here, bi satisfies the equation (2-1).
gcd(λ(M),P_{b}_{₁}_{b}_{₂} _{. . . b}ₐ)=1 (3-1)
Hereinafter, the 2^{a}-2 indexes b₁b₂ . . . bₐ are expressed as “B”. “λ(M)” is called as Carmichael function and is given by the equation (3-2):

$$λ ( M ) = \frac{( {q}_{1} - 1 ) ( {q}_{2} - 1 )}{gcd ( {q}_{1} - 1 , {q}_{2} - 1 )} \qquad ( 3 \text{-} 2 )$$

The key management center assigns the prime number pₐ to the subsets S_{k,B}, and publishes each p_{B} and the assignment as the public information PI. Also, “E” is determined as the product of all the prime numbers P_{B} assigned to all the subsets S_{k,B} defined to the node vₖ. Namely, E=p_{00 . . . 001}p_{00 . . . 010}p_{00 . . . 011} . . . p_{11 . . . 100} . . . p_{11 . . . 001}p_{11 . . . 110}.

The key management center chooses g₁εZ*_{M} at random, and determines the encryption/decryption keys L_{1,B} assigned to the 2^{a}−2 subsets S_{1,B} defined to the node vₖ as the equation (3-3):
L_{1,B}=g₁^{E/p}^{ₐ}modM (3-3)
Here, Z*_{M} is a set of residue class rings Z_{M}={0, 1, . . . , M−1} which has a positive integer M as a modulus and which is relatively prime to M. This is called “irreducible residue class”, and forms group in respect of multiplication. Also, “g₁” is confidentially stored by the key management center.

For the set S_{1,11 . . . 1} including all the receivers, the encryption/decryption keys L_{1,11 . . . 1} to be assigned are determined as follows:
L_{1,11 . . . 1}=g₁^{E}modM (3-4)
Here, in the subsets defined to an arbitrary internal node vₖ, the following index set is defined for each of the “a” nodes vⱼ which are child nodes of vₖ. The set of the indexes B of the subsets S_{k,B} including the receivers assigned to the descendant leaves of vⱼ is defined as the index set ALⱼ. Next, for each of the child nodes vⱼ, the master keys given by the equation (3-5) is defined:

$$\begin{matrix}{MK}_{k , j} = {g}_{k}^{{π}_{i ε {AL}_{j}^{{p}_{l}}}} mod M \\ = {g}_{k}^{R} {/}^{{π}_{i ε {AL}_{j}^{{p}_{j}}}} mod M\end{matrix} \qquad ( 3 \text{-} 5 )$$

From the master keys defined by the equation (3-5), the encryption/decryption keys assigned to the subsets S_{k,i}(iεALⱼ) having the indexes included in the index set ALⱼ, out of the subsets S_{k,B} defined to the node vₖ, can be calculated as shown in the equation (3-6):

$${L}_{k , i} = ( {MK}_{k , j} ) {\prod }_{i ∈ {AL}_{j}}^{{p}_{i} / {p}_{t}} mod M \qquad ( 3 \text{-} 6 )$$

However, for the subsets S_{k,i}(iεALⱼ) having the indexes not included in the index set ALⱼ, it is difficult to obtain the pᵢ-th power root of the master key MK_{k,j}, and hence the encryption/decryption keys L_{k,i}(iεALⱼ) cannot be obtained.

Next, let us consider the encryption/decryption keys L_{4,B} assigned to the 2^{a}−2 subsets S_{4,B} defined to the node v₄ which is the child node of v₁, in the case of the tree structure in which a=3 and N=27 as shown in FIG. 2. First, MK_{1,4} defined by the equation (3-7) is calculated for the child node v₄.

$$\begin{matrix}{MK}_{1 , 4} = {g}_{l}^{{π}_{i ε {AL}_{4}^{{p}_{l}}}} mod M \\ = {g}_{l}^{E} {/}^{{π}_{i ε {AL}_{4}^{{p}_{j}}}} mod M\end{matrix} \qquad ( 3 \text{-} 7 )$$

Similarly to the node v₁, the encryption/decryption keys L_{4,B} assigned to the 2^{a}−2 subsets S_{4,B} defined to the child node v₄ are determined as the equation (3-8):
L_{4,B}=g₄^{E/p}^{ₐ}modM (3-8)
Here, g₄ is defined by the equation (3-9):
MK_{1,4}=PRP(g₄^{E}) (3-9)

Pseudo Random Permutation (PRP) is a bijective function having an input and an output of integer not smaller than 0 and smaller than M. However, a power residue function having modulus of M cannot be used as the PRP. This PRP is opened to all the receivers. Hereinafter, “PRP⁻¹” is used as the inverse function of PRP.

The key management center calculates g₄^{E} from MK_{1,4} using PRP⁻¹, and then calculates E-th power root of g₄^{E} to obtain g₄. Since the key management center owns the prime factors q₁, q₂ of the modulus M, λ(M) in the equation (3-2) can be obtained. When λ(M) is obtained, a multiplicative inverse element D of E having λ(M) as the modulus is obtained by Euclidean algorithm, and the equation (3-10) can be calculated:
g₄=PRP⁻¹(MK_{1,4})^{D} (3-10)

In the above description, PRP is used when MK is calculated from g, and PRP⁻¹ is used when g is calculated from MK. Alternatively, PRP⁻¹ may be used to calculate MK from g, and PRP may be used to calculate g from MK.

For g₄ thus calculated, by the same method as performed for the node v₁, the encryption/decryption keys L_{4,B} can be assigned to the subsets S_{4,B} defined to the node v₄ as shown in the equation (3-8).

Thereafter, for all the internal nodes vₖ (k=1, 2, . . . , (N−1/(a−1)), the encryption/decryption keys L_{k,B} are assigned to the subsets S_{k,B} defined to the node vₖ in the same manner.

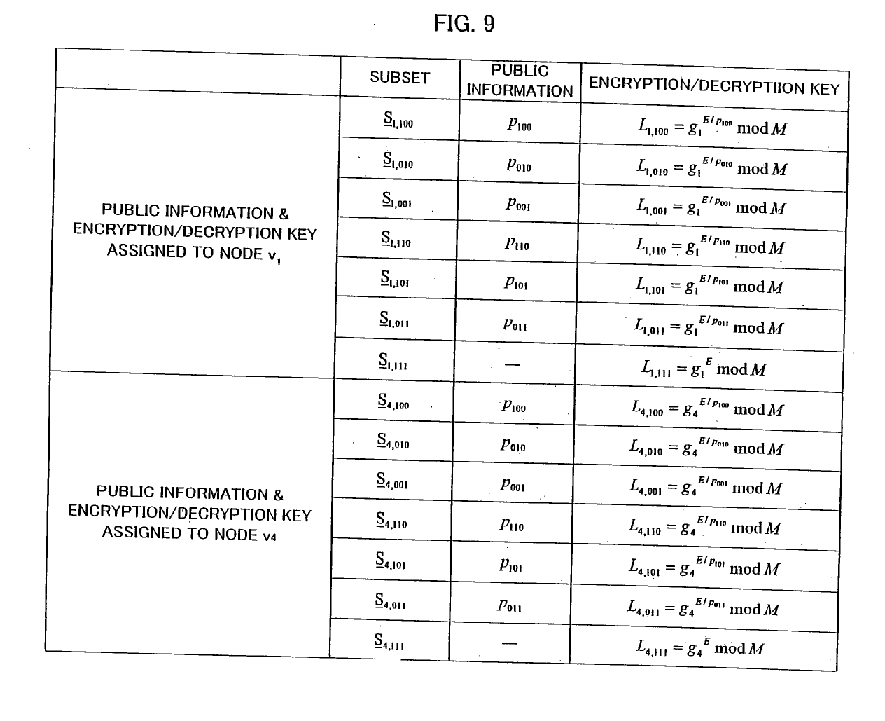

For example, FIG. 9 shows, the assignment of the encryption/decryption keys L_{1,B} and L_{4,B} to the subsets S_{1,B} and S4,B defined to the nodes v₁ and V₄, in the case that a=3 and N=27.

In the above-described method, the prime number is not assigned, as the public information, to the subsets S_{1,11 . . . 1} including all the receivers. This aims to reduce the amount of the public information (number of prime numbers). However, the prime number may be assigned to the subsets S_{1,11 . . . 1} including all the receivers. If the prime number p_{1,11 . . . 1} is assigned, the encryption/decryption key L_{1,11 . . . 1} to be assigned is given by the equation (3-11):
L_{1,11 . . . 1}=g₁^{E/p}^{_{i1 . . . 1}} modM (3-11)

There is no problem if this case is considered that, for arbitrary internal nodes vᵢ, the prime numbers p_{i,11 . . . 1} are assigned, as the public information, to the subsets S_{i,11 . . . 1} including the receivers assigned to all the leaves existing under vᵢ. In this case, the encryption/decryption keys assigned to the subsets S_{i,11 . . . 1} are given as follows:
L_{i,11 . . . 1}=g₁^{E/p}^{_{11 . . . 1}}modM (3-12)

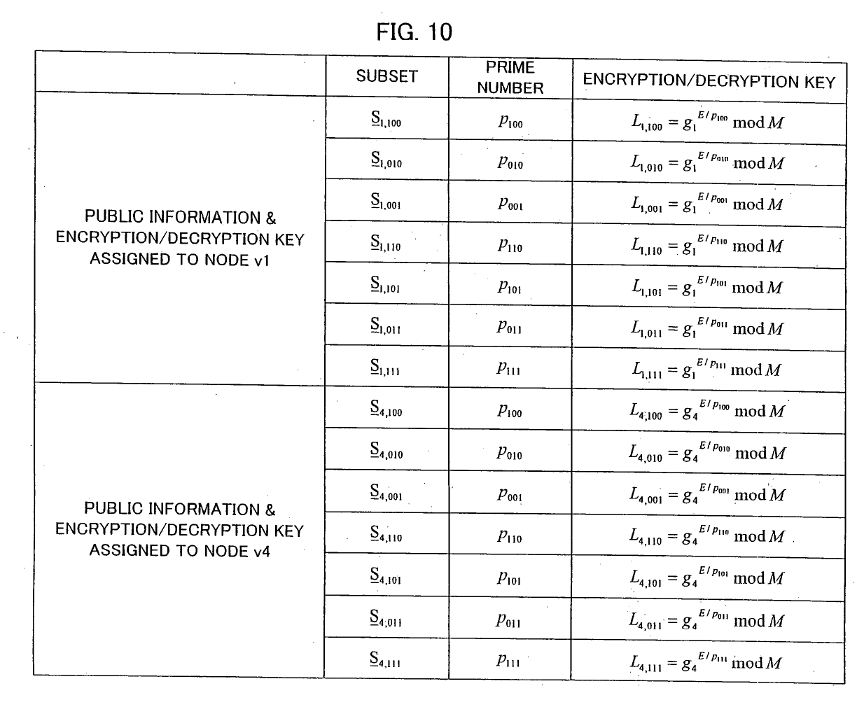

FIG. 10 shows an example of assigning the encryption/decryption keys to the subsets defined for v₁ and v₄ in the case that a=3 and N=27. When the above assignment is performed, the subsets S_{i,11 . . . 1} constituted by the receivers assigned to all the leaves existing under the arbitrary internal node vᵢ are doubly defined. This is because the subsets defined to each of the internal nodes increases from 2^{a}2 to 2^{a}−1. For example, the subsets S_{1,001} and the subsets S_{4,111} in FIG. 10 are both constituted by the receivers u₁₉ to u₂₇, and the encryption/decryption keys L_{1,001} and L_{4,111}, assigned to the respective subsets have the relationship shown by the equation (3-13). In this case, either value may be used.

$$\begin{matrix}{L}_{1 , 001} = {{MK}_{1 , 4}}^{{π}_{i ε {AL}_{4}^{{p}_{j} / {p}_{001}}}} mod M \\ = {PRP ( {L}_{4 , 111} )}^{{π}_{i ε {AL}_{4}^{{p}_{j} / {p}_{001}}}} mod M\end{matrix} \qquad ( 3 \text{-} 13 )$$

(2.1.2) Method of Assigning SIᵤ and PIᵤ to each receiver u, and method of calculation, encryption/decryption keys L_{k,B} from SIᵤ and PIᵤ

The key management center gives 2^{a}−2 prime numbers p_{b1b2 . . . ba} to the receiver u as the public information. Here, bᵢ satisfies the above-mentioned equation (2-1).

Further, to the parent node vk_{logaN} of the receiver u, the master keys defined by the equation (3-5) are assigned to the receiver u as the confidential information SIᵤ. If the leaf to which the receiver u is assigned is vk_{logaN+1}, the confidential information stored in the receiver u is given by the equation (3-14):

$$\begin{matrix}{SI}_{u} = {MK}_{{k}_{{log }_{4} N} , {k}_{{log}_{4} N + 1}} = {{g}_{{k}_{{log}_{4} N}}}^{{π}_{i ε {AL}_{N + 1}^{{p}_{j}}}} mod M \\ = {{g}_{{k}_{{log}_{4} N}}}^{E} {/}^{{π}_{i ε {AL}_{{log}_{4} N + 1}^{{p}_{j}}}} mod M\end{matrix} \qquad ( 3 \text{-} 14 )$$

In the subset Sk_{logaN,B} defined to the node vk_{logaN}, the subset including the receiver u is the subset Sk_{logaN,1} (lεALk_{logaN+1}) having the index included in the index set ALk_{logaN+1}. The encryption/decryption keys Lk_{logaN,1} (1εALk_{logaN+1}) assigned to the subsets Sk_{logaN,1} (lεALk_{logaN+1}) can be calculated by the method indicated by the equation (3-6).

Next, the master keys MKk_{logaN+1}, k_{logaN} defined to the parent node vk_{logaN-1} of the node vk_{logaN} is calculated by the equation (3-15):

$$\begin{matrix}{MK}_{{k}_{{log}_{4} N + 1} , {k}_{{log}_{4} N}} = PRP ( {MK}_{{k}_{{log}_{4} N} , {k\_log}_{4} N + 1}^{{π}_{i ε {AL}_{{i}_{{log}_{4} N - 1}}^{{p}_{j}}}} mod M ) \\ = PRP ( {g}_{{k}_{{log}_{4} N}}^{R} mod M ) \\ = {g}_{{k}_{{log}_{4} N - 1}}^{R / {π}_{i ε {AL}_{{log}_{4} N}^{{p}_{j}}}} mod M\end{matrix} \qquad ( 3 \text{-} 15 )$$

Similarly to the case of the node vk_{logaN}, out of the subsets Sk_{logaN-1,B} defined to the node vk_{logaN-1}, the encryption/decryption keys Lk_{logaN-1,1} (lεALk_{logaN}) assigned to the subsets Sk_{logaN-1,1} (1εALk_{logaN,B}) including the receiver u can be calculated by the method indicated by the equation (3-6).

By repeating the same process up to the root node v₁, the encryption/decryption keys assigned to all the subsets including the receiver u can be obtained. Finally, the encryption/decryption keys L_{1,11 . . . 1} assigned to the subsets S_{1,11 . . . 1} including all the receivers can be obtained by the calculation of the equation (3-16);

$${L}_{1 , 11 … 1} = {MK}_{1 , {k}_{1}} {\prod }_{i ∈ {AL}_{j}}^{{p}_{t}} mod M \qquad ( 3 \text{-} 16 )$$

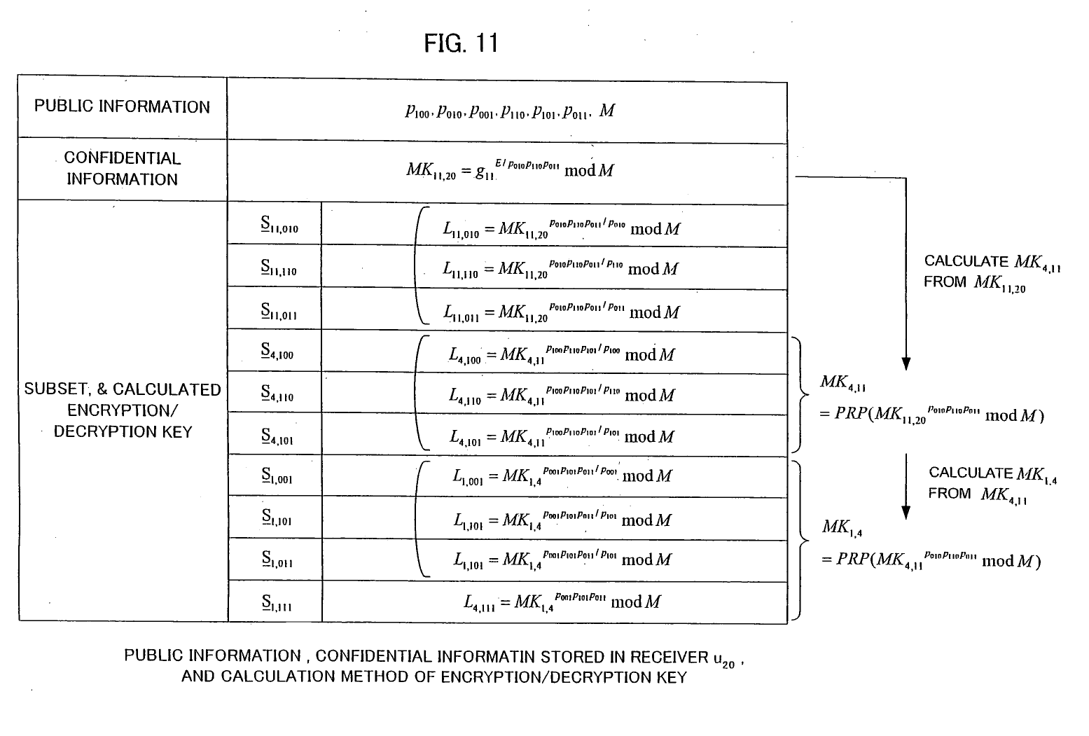

For example, FIG. 11 shows the confidential information SIᵤ₂₀ and the public information stored in the receiver u₂₀, as well as the calculation method of the encryption/decryption keys from them, in the case that a=3 and N=27. The master key MK_{4,11} assigned to the node v₁₁ is calculated from the confidential information MK_{11,20} assigned to the receiver u₂₀, and the master key MK_{1,4} assigned to the node v₄ is calculated from the master key MK_{4,11}. Then, the encryption/decryption key is obtained from the master keys MK_{11,20}, MK_{4,11} and MK_{1,4}.

(2.1.3) Comparison of Each System

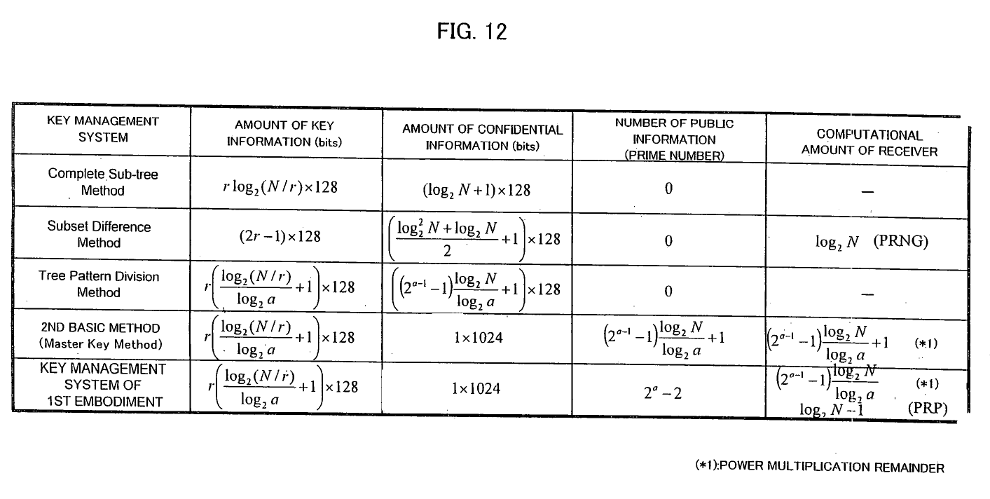

In the following, the key management system according to the first embodiment and the conventional key management system are compared in view of the performances. The comparison of the conventional method and the key management system of the first embodiment in view of the performances is shown in FIG. 12. FIG. 12 compares, for each key management system, the amount of the transmitted key information, the amount of confidential information stored in the receiver, the amount of the public information stored in the receiver, and the computational amount by the receiver to calculate the decryption key from the confidential information and the public information. In FIG. 12, “r” is the number of the receivers to be revoked, “N” is the total number of the receivers (i.e., number of the leaves), and “a” is the number of division of the tree.

The Complete Sub-tree Method directly stores the decryption keys as the confidential information, and the amount of the decryption keys stored in the receiver is small, but the amount of the key information is large. Conversely, in the Subset Difference Method, the amount of the confidential information stored in the receiver is large, but the amount of the key information is small. In those two key management systems, relationship between the amount of the transmitted key information and the amount of the confidential information stored in the receiver is trade-off. Therefore, if one is decreased, the other increases. On the other hand, it is understood that the Tree Pattern Division Method has an intermediate characteristic of the above-mentioned key management systems.

In the second basic method (i.e., Master Key Method described in the above-mentioned document), plural encryption/decryption keys are calculated from one confidential information using the public information. Therefore, although the receiver stores one confidential information, the amount of the transmitted key information does not increase. In the Complete Sub-tree Method, the Subset Difference Method and the Tree Pattern Division Method, the amount of the confidential information stored in the receiver includes “N” as a parameter, and hence the confidential information increases when the total number of the receivers N is large. However, in the second basic method, it is sufficient that the receiver stores the confidential information of 1024 bits even if the total number N of the receivers is large.

Although the second basic method has the above-mentioned advantage, it has such a disadvantage that a lot of public information (prime number) are needed to calculate the encryption/decryption keys from the confidential information. Since it is public information, it can be transmitted as the key information at the time of transmitting the encrypted information, instead of being stored in the receiver in advance. However, the amount of the transmitted information increases in that case. In addition, while FIG. 12 does not show, the number of the prime numbers used in the whole system is (2^{a}−2)(N−1)/(a−1)+1, which is quite large, and the key management center must generate and manage all of those prime numbers.

In the key management system according to the first embodiment of the invention similarly to the second basic method described above, the amount of the confidential information stored in the receiver does not include the total number N of the receivers as a parameter. Therefore, only one (1024 bits) confidential information is sufficient even if the total number N of the receivers is large. Although the second basic method requires large number of public information (prime numbers) stored in the receiver, the key management system according to the first embodiment requires 2^{a}−2, i.e., less number of public information. Therefore, the number of public information (prime numbers) used by the whole system is small, and hence the key management system can easily generate and manage them.

The key management system according to the first embodiment employs the system in which all the master keys, defined to the nodes existing on the path from the leaf to which the receiver is assigned to the root can be obtained, in sequence, from the master keys defined to the nodes at the lower layers. In addition, the relationship between the encryption/decryption keys assigned to the subsets respectively defined to two nodes in a parent-child relationship are set to uncorrelated values by using the bijective function PRP. Thus, the assignment of the encryption/decryption keys using the master keys can be carried out independently between plural nodes, and hence the amount of the public information (number of the prime numbers) can be remarkably reduced.

(2.2) Method According to Second Embodiment

In the key management system of the second embodiment, out of two types of systems, i.e., a system in which master keys are used to assign encryption/decryption keys to the subsets, and a system in which encryption/decryption keys set to values independently are directly assigned to the subsets, those systems are used in combination only for a system in which definition of all the subsets and the division method of the set N\R are identical. Specifically, the key management system according to the above first embodiment is used as the system in which the master keys are used, and the Tree Pattern Division Method described in the first basic method is used as the system in which encryption/decryption keys set to values independently are directly assigned to the subsets.

(2.2.1) Method of Assigning Encryption/Decryption Keys T_{k b1b2 . . . ba} and Public information PI to Each Subset S_{k,b1b2 . . . ba}

The assignment of the encryption/decryption keys T_{k,b1b2 . . . ba} and public information PI to each subset S_{k,b1b2 . . . ba} is carried out by using the system, described first in the first embodiment, which uses the master key technique. Thereafter, the encryption/decryption keys L_{k,b1b2 . . . ba} thus assigned are converted by using mapping function h (given by the equation (3-17)), introduced in the Document-1, which maps factors randomly distributed on Z*_{M} to random number sequence of arbitrary length t, and the result of the conversion are used as the encryption/decryption keys to be assigned to the subsets.
h:Z*_{M}* [symbol] {0,1} (3-17)

For example, when the key length of the encryption/decryption keys used in the encryption (decryption) algorithms E_{enc}, E_{dec} of the session keys is 128 bits, the encryption/decryption key L_{k,b} assigned to the subset S_{k,B} by the key assignment according to the key management system of the first embodiment is mapped to the 128 bits random number sequence T_{k,b}=h(L_{k,b}). This is assigned to the subset S_{k,B}, and used as the encryption/decryption key.

(2.2.2) Method of Assigning SIᵤ and PIᵤ to each receiver u, and calculation method, encryption/decryption keys T_{k,B} from SIᵤ and PIᵤ

Each receiver is able to choose one of two key management systems according to its environment and implementing form.

The system in which the key management system using the first embodiment is implemented, the method described in (2.1.2) is used, The different point is that, after deriving the encryption/decryption key L_{k,B} assigned to the subset S_{k,B} from the confidential information SIᵤ, the value calculated by using the function T_{k,b}=h(L_{k,b}) is used as the encryption/decryption key.

On the other hand, when the system in which encryption/decryption keys set to values independently are directly assigned to the subsets, described in the first basic method, is implemented, the method described in (1.2.3) is used. However, the encryption/decryption key assigned to the receiver is T_{k,b}=h (L_{k,b}).

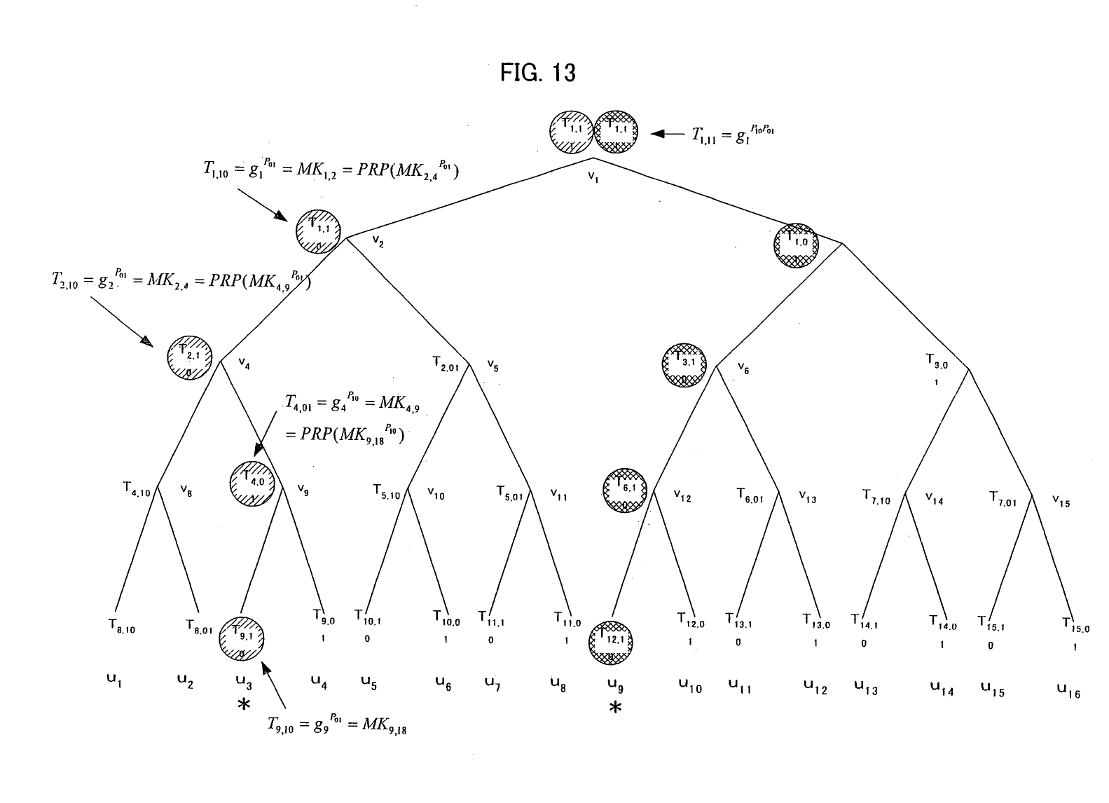

FIG. 13 shows, as an example, the key management system according to the second embodiment in the case that a=2 and N=16. In this example, the receiver U₃ chooses the system using the key management system of the first embodiment, and the receiver u_{g} chooses the system using the key management system of the first basic method. In this case, the receiver u₃ owns p₁₀, p₀₁ as the public information, and MK_{g,18}=g_{g}^{E/p10}=g^{p01}=T_{9,10} is assigned as the confidential information. By using this confidential information, the receiver u₃ obtains the encryption/decryption keys T_{1,11}, T_{1,10}, T_{2,10}, T_{4,01}, T_{9,10}. On the other hand, to the receiver u₉, only the encryption/decryption keys T_{1,11}, T_{1,01}, T_{3,10}, T_{6,10}, T_{12,10} are assigned as the confidential information.

It is noted that, in the above description, the key management system according to the first embodiment is described as the system in which the master keys are used to assign the encryption/decryption keys to the subsets. However, it may be replaced with the key management system described in the second basic method.

(2.2.3) Effect in Using the Key Management System According to the Second Embodiment

As described above, in the three methods; the Complete Sub-tree Method, the Subset Difference Method and the Tree Pattern Division Method, the amount of the confidential information stored in the receiver has “N” as the parameter, and hence the amount of the confidential information stored in the receiver increases if the number N of the total receivers is large. However, the calculation to obtain the decryption keys from the confidential information is not necessary.

On the contrary, in the second basic method (Master Key Method) and the key management system according to the first embodiment, it is sufficient for the receiver to stores the confidential information of only 1024 bits even if the total number N of the receivers is large. However, a lot of public information (prime numbers) are required to calculate the encryption/decryption keys from the confidential information. If the receiver does not store the public information in advance and the public information is transmitted as the key information at the time of transmitting the encrypted data, the information transmission amount increases. If all of the public information (prime numbers) used in the system is stored in the server having the role of the public bulletin board and the receiver accesses the server to download and use the public information (prime numbers) to calculate the encryption/decryption keys at the time of receiving the data, it can be avoided that the receiver directly stores a large number of public information. However, the above method is not applicable to the off-line application that is not connected to the network. Further, a large number of modulo exponentiation operation is needed.

As described above, depending upon the environment of the receiver (e.g., on-line or off-line), or the implementing form (e.g., PC equipment or CE equipment), suitable key management system is changed.

Therefore, in an environment in which the form of the receiver has the operational capability, such as PC, and software implementation is possible, the second basic method and the system of the first embodiment are suitable. The PC has an on-line environment in many cases, such implementation that the public information is transmitted online or is downloaded from the public bulletin board can be readily achieved. Also, in the software implementation in PC, the confidential information is directly embedded to the program. In that case, the program should be difficult to read in order to protect it from illegal analysis. The confidential information as small as possible is desirable because the size of the program difficult to read becomes large if the size of the data to be protected is large. Taking this into consideration, in making the protected program, the second basic method and the system of the first embodiment are suitable for implementation.

On the other hand, when it is desired that the receiving device is implemented at low cost in the hardware environment such as CE equipment, the implementation of modulo exponentiation operation circuit remarkably increasing the circuit scale needs to be avoided. Also, since the off-line environment is expected and the amount of the public information directly affects the memory capacity loaded on the product, the Complete Sub-tree method and the Tree Pattern Division Method, that include no public information and relatively small confidential information, are suitable for the implementation.

For the above reasons, the key management system according to the second embodiment enables the choice-of two key management systems according to the environment of the receiver and implementation form. Also, in this case, the key management center can treat as if it manages all the receivers by one key management system, regardless of the implementation forms of the receivers. In this way, in the key management system of the second embodiment, the system in which the key management center needs to manage less information is chosen, and the receiver can choose the key management system suitable to its environment and implementation form.

(2.3) Contents Providing System of Embodiments

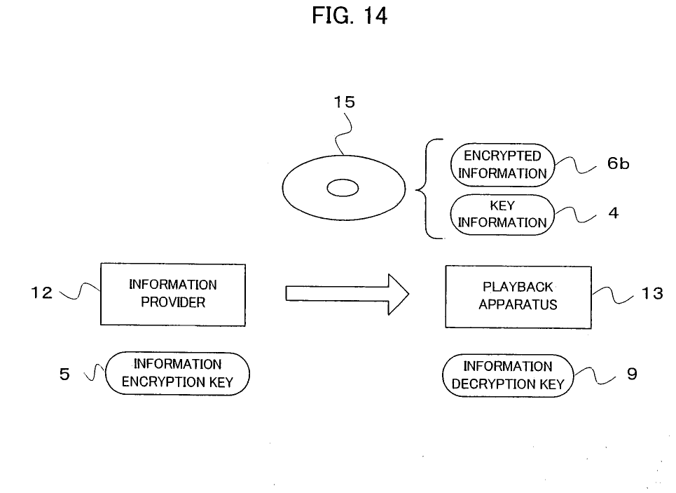

FIG. 14 shows a schematic construction of a contents providing system according to the embodiment of the invention. In this system, the information provider 12 provides various recording medium 15 to a user. In this embodiment, the recording medium 15 may be various recording medium including an optical disc such as DVD-ROM. The user has a playback apparatus 13, and plays back information from the recording medium 15 by the play back apparatus 13. The playback apparatus 15 has information decryption key 9 in its inside.

As shown in FIG. 1, the information provider 12 corresponds to the information transmitter of the three constitutive elements of the key management system, and the playback apparatus 13 corresponds to the information receiver. Namely, the information provider 12 encrypts the contents information such as video/audio by using the information encryption key 5, and records it on the recording medium as the encrypted information 6b. Also, the information provider 12 records the key information, on the recording medium 15, which cannot be decrypted by the revoked playback apparatus 13 but can be decrypted by the non-revoked play back apparatus 13. Then, the information provider 12 provides the recording medium 15 to each user of the playback apparatus 13.

The non-revoked playback apparatus 13 not subjected to the revocation decrypts the key information 4 by using its information decryption key 9 to obtain the decryption key of the encrypted information 6b, and decrypts the encrypted information 6b to play back the information such as video/audio. On the contrary, the revoked playback apparatus 13 cannot decrypt the key information 4 in the recording medium 15 by its information decryption key 9, and cannot obtain the key to decrypt the encrypted information 6b. Hence, it cannot play back the encrypted information 6b. In this way, in this system, the encrypted information 6b recorded on the recording medium 15 can be played back only by specific playback apparatuses 13.

In this invention, the information decryption key 9 on the side of the playback apparatus 13 and the key information 4 recorded on the recording medium 15 are generated in accordance with either one of the key management systems given by the above-mentioned first and second embodiments. Specifically, the playback apparatus 13 generates the information decryption key 9 from the key information 4 obtained from the recording medium 15, the confidential information (corresponding to the playback apparatus) given by the key management center and the public information. In the case of the key management system according to the first embodiment, since the information amounts of the confidential information and the public information are small, the information amount to be stored in the playback apparatus 15 can be reduced. On the other hand, in the key management system according to the second embodiment, if the playback apparatus 13 is a CE equipment, the playback apparatus 13 chooses the key management system requiring small computational amount of the decryption key, and generates the information decryption key 9 from the confidential information and the key information 4. By using the key management system according to the second embodiment, the playback apparatus 13 can choose the key management system suitable for the implementation form, and can efficiently decrypt the encrypted information 6b.

(3) Specific Example of Contents Providing System

Next, a specific example of the contents providing system according to the embodiment of the invention will be described. This contents providing system uses an optical disc such as a DVD as the recording medium, and the example of a DVD-ROM will be described below. In this contents providing system, the information transmitter corresponds to a copyright holder or an optical disc manufacturing factory. On the other hand, the information receiver is an apparatus (playback apparatus) having a playback function of the contents, which is configured by a hardware or a software.

In the following description of the embodiment, “Encryption[ ]” indicates the encryption algorithm, and “Decryption[ ]” indicates the decryption algorithm. “Encryption[Argument1, Argument2]” indicates a cipher text obtained by encrypting Argument1 by using Argument2 as the encryption key, and “Decryption[Argument1, Argument2]” indicates the data obtained by decrypting Argument1 by using Argument2 as the decryption key. The symbol “|” indicates the concatenation of two data and used as “(DataA)|(DataB)”.

(3.1) Contents Recording Apparatus

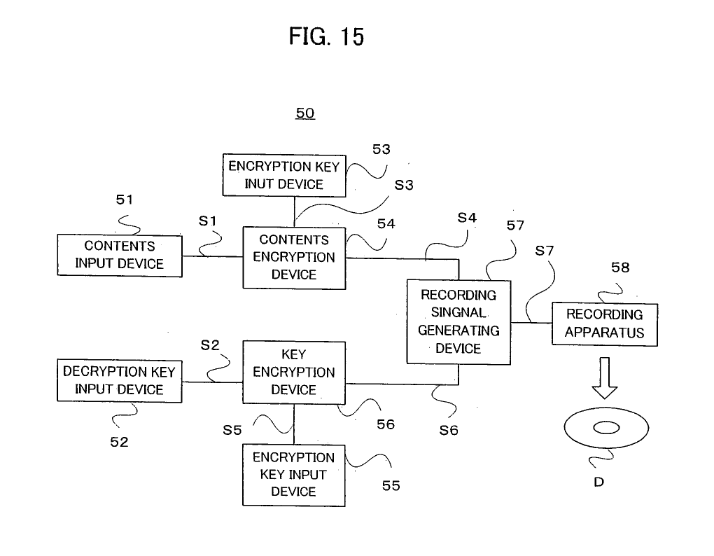

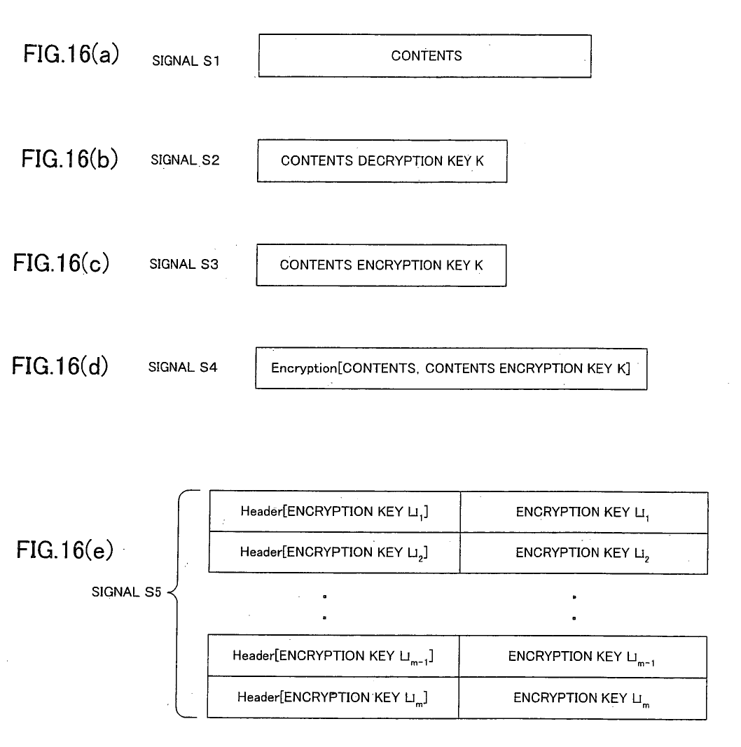

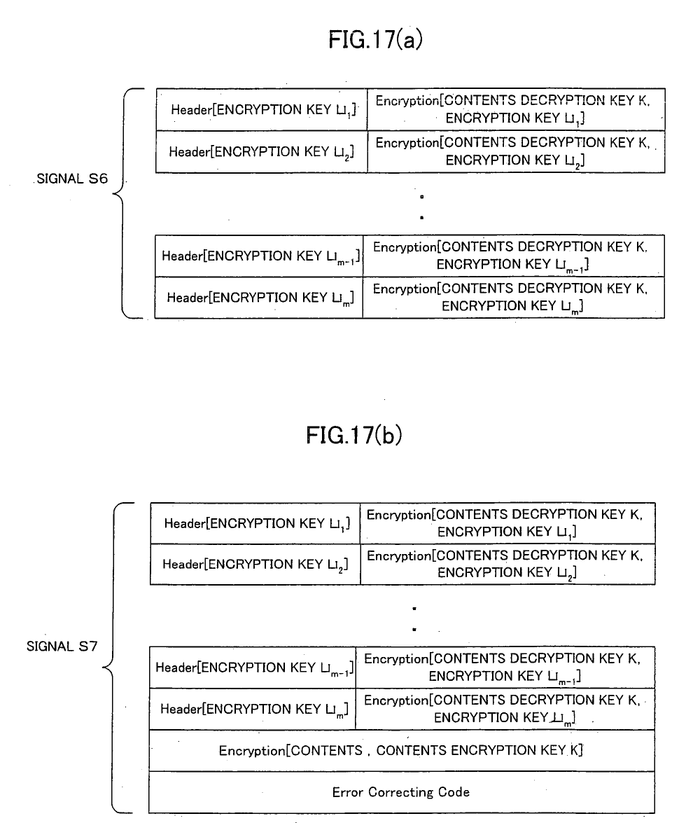

First, a contents recording apparatus will be described. FIG. 15 is a block diagram showing a construction of a contents recording apparatus 50 which records the contents on a disc. The contents recording apparatus 50 is provided in the above-mentioned disc manufacturing factory serving as the information transmitter. FIGS. 16 and 17 shows the signals S1 to S7 of each part of the contents recording apparatus 50. The contents here correspond to the above-mentioned encrypted information which is transmitted from the information transmitter to the information receiver.

In FIG. 15, the contents input device 51 is a device which inputs the contents, and outputs the signal S1 corresponding to the contents, as shown in FIG. 16(a). The typical example of the contents are generally multi-media data such as music, video and the like, but the contents here are not limited to those and may include data such as text. The contents input device 51 may be a circuit which reads a recording medium, such as a magnetic tape, a DVD-R, a DVD-RW, a DVD-ROM, a DVD-RAM on which master data of the contents are recorded, so as to output the signal S1, or a circuit which makes access via a communication line such as a LAN and the Internet to download the data and outputs the signal S1.

The decryption key input device 52 is a device which inputs the contents decryption key K, and outputs the signal 52 corresponding to the contents decryption key K as shown in FIG. 16(b). The contents decryption key K is determined by a copyright holder, a disc manufacturing factory or the key management center.

The encryption key input device 53 is a device which inputs the contents encryption key K, and outputs the signal S3 corresponding to the contents encryption key K as shown in FIG. 16(c). It is required that the contents encryption key K and the contents decryption key K have the following relationship;
P=Decryption[Encryption[Arbitrary Data P,Contents Encryption Key K],Contents Decryption Key]

The contents encryption device 54 encrypts the contents (the signal S1) by using the contents encryption key K (the signal S3), and outputs the encrypted contents as the signal S4. The signal S4 is shown in FIG. 16(d).

In this example, the contents are directly encrypted by using the contents encryption key K, it is not necessary to encrypt the contents itself. For example, the contents itself may be encrypted by other encryption key C, and the decryption key C corresponding to the encryption key C may be encrypted by the contents encryption key K and outputted as the signal S4. Namely, “Encrypting the contents by using the contents encryption key” described here means that the contents are converted in such a manner that at least the contents decryption key K is needed to decrypt the contents.

The encryption key input device 55 is a device which inputs plural encryption keys Lᵢ for encrypting the contents decryption key K, and chooses m encryption keys L_{I1}, L_{I2}, . . . , L_{Im-1}, L_{Im} according to the above-mentioned algorithm of the key management system to output the signal S5. The signal S5 is shown in FIG. 16(e). By the combination of the plural encryption keys L_{I1}, L_{I2}, . . . , L_{Im-1}, L_{Im}, the playback apparatus that can plays back the contents (the above-described “non-revoked receiver ”) is uniquely determined. Therefore, the encryption key L_{Ii} is determined by an organization having a right to permit the playback (the key management center or the information transmitter). Header[Encryption key L_{I1}], Header[Encryption key L_{I2}], . . . Header[Encryption key L_{I1-1}], Header[Encryption key L_{Im}] show the identification information of the encryption keys L_{I1}, L_{I2}, . . . , L_{Im-1}, L_{Im}, and are the same as the index part (i₁, i₂, . . . , iₘ] of the equations (1-2) and (1-3). Here, “Header[Encryption key L]” is called the header of the encryption key L.

The key encryption device 56 encrypts the contents decryption key K obtained as the signal S2 by using the encryption key L_{Ii} obtained as the signal S5, and outputs the signal S6. FIG. 17(a) shows the signal S6. In the following description, for the sake of simplicity, the signal S6 is expressed as follows:
“Signal S6=Header[Encryption key L]|Encryption[Contents decryption key K, Encryption key K]”

The recording signal generating device 57 generates the recording signal by concatenating the encrypted contents and the contents decryption key K encrypted by the plural encryption keys L_{Ii}. More specifically, the recording signal generating device 57 concatenates the signal S4=Encryption[Contents, Contents encryption key K], the signal S6=Header[Encryption key L]|Encryption[Contents decryption key K, Encryption key L] and the error correction code, and outputs the result of the concatenation as the signal S7. Therefore, as shown in FIG. 17(b), the signal S7 includes the contents encrypted by the contents encryption key K, the contents decryption keys K encrypted by m encryption keys L_{Ii} and the error correction code. “ECC” is Error Correction Code.

The recording device 58 records the recording signal 57 thus generated onto the optical disc D, or cuts the recording signal S7 onto a master disc used to manufacture the optical discs. The recording device 58 normally includes a laser light source or a laser oscillator.

(3.2) Contents Playback Apparatus

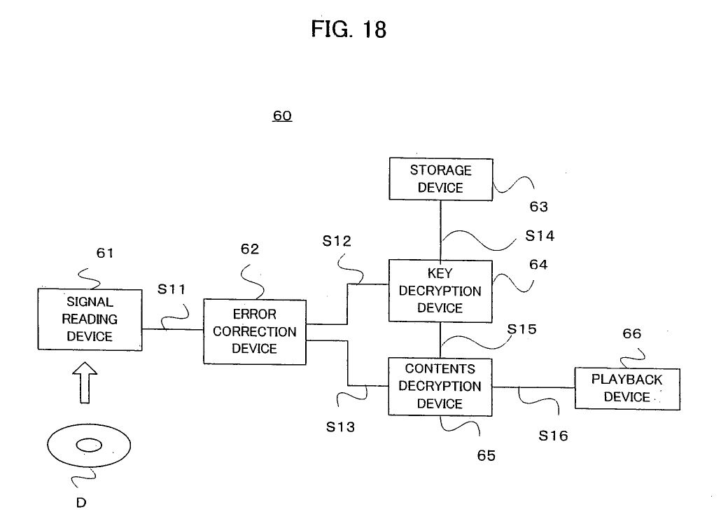

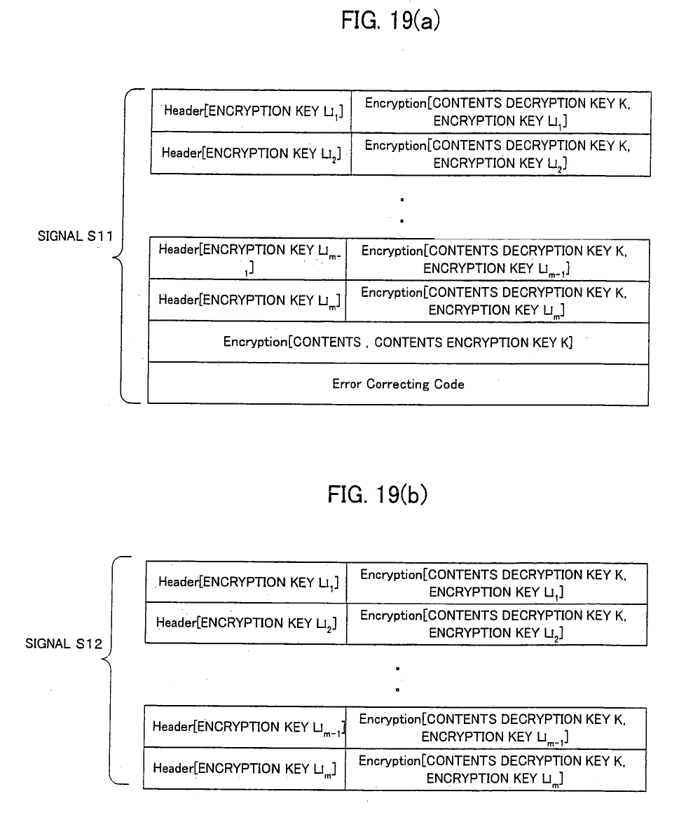

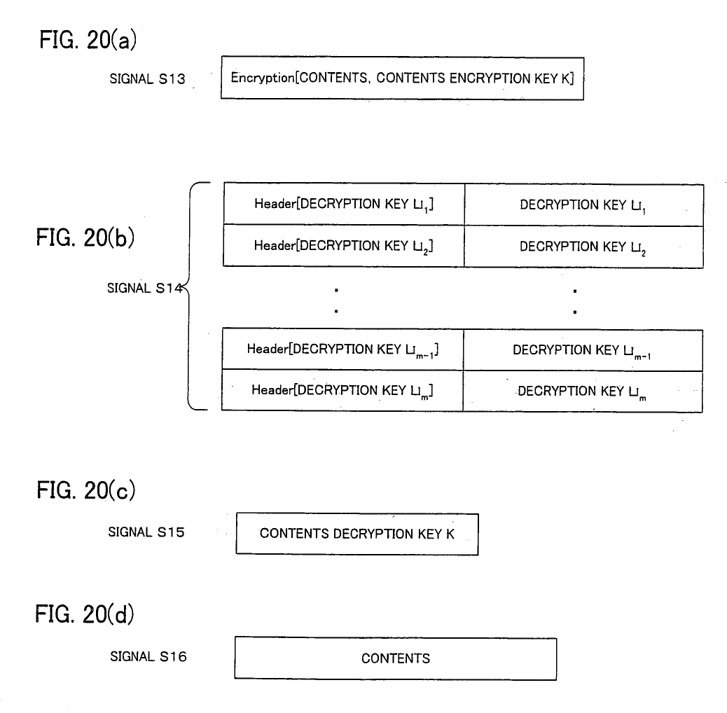

Next, the contents playback apparatus 60 which plays back the contents from the optical disc D on which the contents are recorded in the above-described manner will be described. FIG. 18 is a block diagrams showing the construction of the contents playback apparatus 60. FIGS. 19 and 20 show the signals of each part in the contents playback apparatus 60.

In FIG. 18, the information reading device 61 is a device such as an optical pickup, and reads the information recorded on the optical disc D to output the signal S11. The signal S11 is shown in FIG. 19(a).

The error correction device 62 is a device which performs the error correction of the inputted signal S11, and carries out the error correction based on the ECC included in the signal S11. Then, the error correction device 62 divides the signal after the error correction to the signals S12 and S13, and supplies them to the key decryption device 64 and the contents decoding device 65, respectively. The signal S12 is the data of the contents decryption key K encrypted by the encryption key Lᵢ, and is expressed by:
S12=Header[Encryption key B]Encryption[Contents decryption key K,Encryption key L]
On the other hand, the signal S13 is the data of the contents encrypted by the content encryption key K, and is expressed by:
S13=Encryption[Contents, Contents encryption key K]

The storage device 63 stores plural decryption keys L_{J1}, L_{J2}, . . . , L_{Jj}, . . . , L_{Jn-1}, L_{Jn} owned by the playback apparatus, and the headers Header[L_{J1}], Header[L_{J2}], . . . , Header[L_{Jj}], . . . , Header[L_{Jn-1}], Header[L_{Jn}]. Here, it is assumed that the storage device 63 stores n decryption keys. Also, the key management center distributes the decryption keys L_{Jj}, in advance, to the playback apparatuses such that either one of the encryption key L_{Ii} for encrypting the contents decryption key K and the decryption key L_{Jj} owned by the playback apparatus for which the playback is permitted satisfies the following relationship:
P=Decryption[Encryption[Arbitrary data P,Encryption key L_{Ii}],Decryption key L_{Jj}]
Further, the values of the headers are determined such that the headers added to the encryption key L_{Ii} and the decryption key L_{Jj} having the above relationship satisfy the following relationship:
Header[Encryption key L_{Ii}]=Header[Encryption key L_{Jj}]

It is the key management center that distributes the decryption key L_{Jj} and the header to each playback apparatus such that the above relationship is satisfied, and determines which decryption key K_{Jj} is distributed to which playback apparatus according to the algorithm of the above-described key management system.

As shown in FIG. 20(b), the storage device 63 outputs Decryption key L_{J1}|Decryption key L_{J2}| . . . |Decryption key L_{Jn-1}|Decryption key Lₙ and the headers Header[Decryption key L_{J1}]|Header[Decryption key L_{J2}]| . . . |Header[Decryption key L_{Jn-1}]|[Header[Decryption key L_{Jn}].

The key decryption device 64 receives the signal S12=Header[Decryption key L|Encryption[Contents Decryption key K, Encryption key L], the signal S14=[Decryption key L_{J1}|Decryption key L_{J2}| . . . |Decryption key L_{Jn-1}|Decryption key L_{Jn}] and the headers Header[Decryption key L_{J1}]|Header[Decryption key L_{J2}]| . . . |Header[Decryption key L_{Jn-1}]|[Header[Decryption key L_{Jn}], and examines whether or not the Header[Encryption key L_{Ii] read from the optical disc and the Header[Decryption key L}_{Jj}] owned by the playback apparatus-coincide with each other. If they coincide with each other, the key decryption device 64 decrypts the Encryption[Contents Decryption key K, Encryption key L_{Ii}] by using the Decryption key L_{Jj}. Namely, Contents Decryption key K=Decryption[Encryption[Contents decryption key K, Encryption key L_{Ii}], Decryption key L_{Jj}]. This process is performed with changing the combination of Iᵢ and Jᵢ so that the combination of the coincident headers is found, and the signal S15=Contents decryption key K is outputted as shown in FIG. 20(c). Thus, the decrypted contents decryption key K is supplied to the contents decryption device 65 as the signal S15. On the other hand, if there is no combination of coincident headers, the playback is impossible and all processes are ended.

The contents decryption device 65 receives the signal S13=Encryption[Contents, Contents encryption key K] shown in FIG. 20(a) and the signal S15=Decryption[Encryption[Contents decryption key K, Encryption key L_{Ii}], Decryption key L_{Jj}]=Contents decryption key K, decrypts the signal S13 by using the signal S15 and outputs Decryption[Encryption[Contents, Contents encryption key K], Contents decryption key K]=Contents as the signal S16. The playback device 66 plays back the contents decrypted by the contents decryption device 65. In this way, the contents is played back only by the playback apparatus for which the playback is permitted.

(3.3) Process in Key Management Center

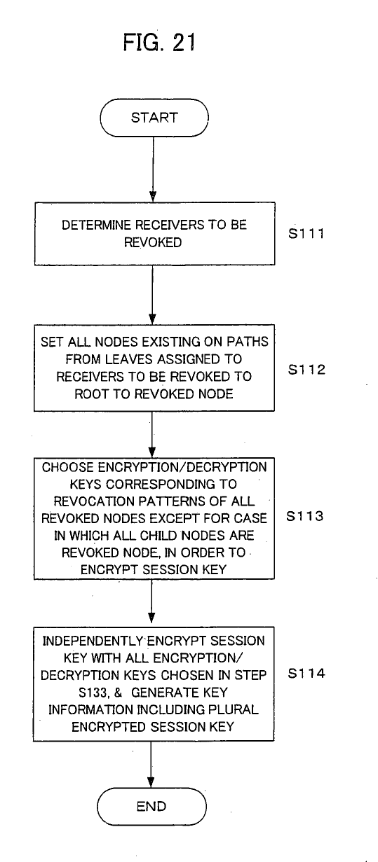

Next, the process in the key management center will be described with reference to FIGS. 21 to 23. The key management center includes a CPU serving as an operation unit and a memory such as a RAM serving as a storage unit. Namely, as described above, the key management center functions as a composite unit which operates a composite number, a first confidential information storage unit which stores first confidential information in association with root node, a public information storage unit which stores public information in association with subsets, a first master key operating unit which operates master keys corresponding to child nodes of the root node based on the first confidential information and the public information, a first master key storage unit which stores the master keys in association with the corresponding child nodes, a second confidential information operating unit which operates second confidential information, for the node, by a bijective mapping function based on the master keys assigned to a parent node having the node as a child node and the composite number, a second confidential information storage unit which stores the second confidential information in association with corresponding arbitrary node, a second master key operating unit which operates the master keys corresponding to the child nodes of each node based on the second confidential information and the public information assigned to each node, a second master key storage unit which stores the master keys in association with the corresponding child nodes, an encryption/decryption key operating unit which operates encryption/decryption key based on the first or second confidential information and the public information assigned to the node for the subsets, and an encryption/decryption key storage unit which stores the encryption/decryption keys in association with corresponding node. In the following, the specific process performed by the key management center will be described. It is noted that the process described below is performed by the information transmitter, such as a copyright holder or a disc manufacturing factory, in some cases.

(3.3.1) Key Information Generating Process

The key information generating process performed by the key management center will be described with reference to FIG. 21.

First, instep S111, the key management center determines the receivers to be revoked (i.e., the receivers for which the reception of the contents is not permitted).

Next, the nodes existing on the paths from the leaves to which the receivers chosen in step S111 are assigned to the root are all set to the revoked node (step S112). Then, the process goes to step S113.

Next, in step S113, in order to encrypt the session key, the encryption/decryption keys corresponding to the revocation patterns of all revoked nodes, except for the case that all the child nodes are the revoked nodes, are chosen.

Next, the session key is independently encrypted with all the encryption keys chosen in step S113 to generate the key information constituted by plural encrypted session keys (step S114). The key management center delivers the key information to the information transmitter.

(3.3.2) First Assigning Process of Encryption Keys to Subsets

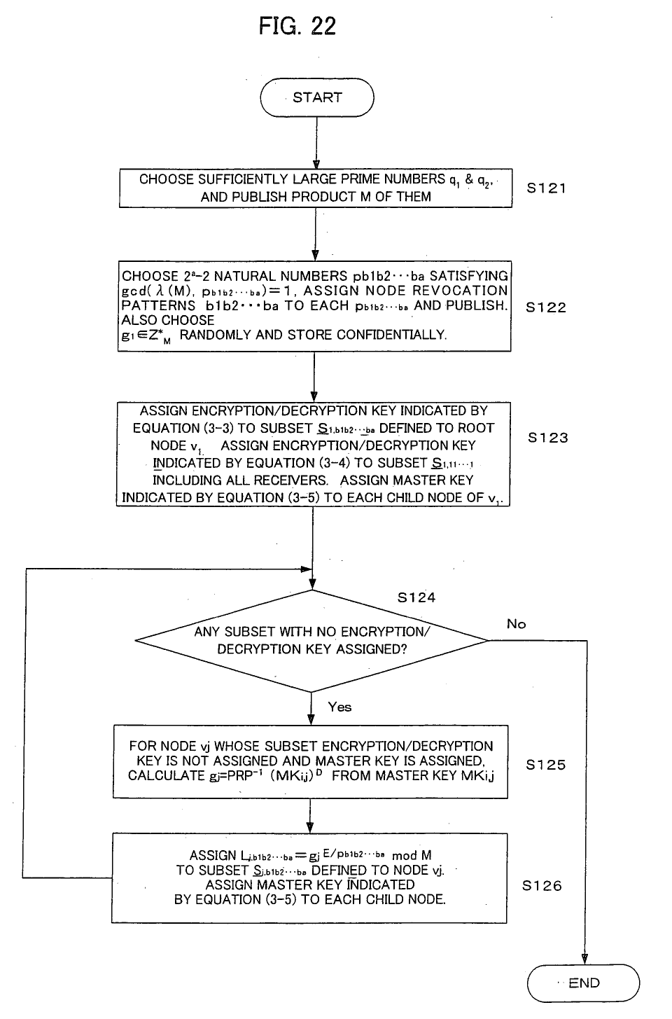

By referring to FIG. 22, the encryption key assigning process performed by the key management center, described in the first embodiment, will be described.

First, in step S121, the key management center chooses two large prime numbers (e.g., larger than 512 bits) q₁ and q₂, and publishes the product M of them as the public information. Then, the process goes to step S122.

In step S122, the key management center chooses 2^{a}−2 natural numbers p_{b1b2 . . . ba} (e.g., prime numbers) which are relatively prime and which satisfy the equation (3-1), assigns each p_{b1b2 . . . ba} to the node revocation patterns b1b2 . . . ba, and publishes the p_{b1b2 . . . ba} and this assignment as the public information. Further, the key management center chooses g₁εZ*_{M} at random. Here, Z*_{M} is a set of residue class rings Z_{M}={0, 1, . . . , M−1} having a positive integer M as a modulus and relatively prime to M. This is called “irreducible residue class”, and forms group in respect of multiplication. Also, “g₁” is confidentially stored by the key management center. Then, the process goes to step S123.

In step S123, the key management center assigns the encryption/decryption keys L_{1,b1b2 . . . ba} to be assigned to 2^{a}−2 subsets S_{1,b1b2 . . . ba} defined to the root node v₁ as the equation (3-3). To the set S_{1,11 . . . 1} including all the receivers, the encryption key indicated by the equation (3-4) is assigned. Also, to each child node vⱼ (j=2 . . . a+1) of v₁, the master key MK_{1,j} given by the equation indicated by the equation (3-5) is assigned. Then, the process goes to step S124.

In step S124, the key management center determines whether there exists a subset to which the encryption/decryption key is not assigned, or not. If there is no such subset (step S124; No), the key management center has already assigned the encryption keys to all the subsets, and hence the encryption/decryption key assigning process to the subsets ends.

On the contrary, if there is a subset to which the encryption/decryption key is not assigned (step S124; Yes), the process goes to step S125. For the node vⱼ to whose subset defined that the encryption key is not assigned and the master key is assigned, the key management center calculates gⱼ=PRP⁻¹(MK_{i,j})^{D} from the master key MK_{i,j} assigned to itself (e.g., calculates by the equation (3-10)). Then, the process goes to step S126.

In step S126, the encryption/decryption keys L_{j,b1b2 . . . ba} are assigned to the subsets S_{j,b1b2 . . . ba} defined to the node vⱼ by using gⱼ obtained as described above, and the master key indicated by the equation (3-5) is assigned to each child node. Then, the process goes back to step S124 to repeat the same process. When the encryption/decryption keys are assigned to all the subsets, the process from step S124 to S126 ends.

In this way, the information transmitter can calculate the encryption key assigned to the subset using the key information, and the information receiver such as the playback apparatus can calculate the decryption key assigned to the subset by obtaining the key information from the information transmitter.

(3.3.2) Second Process of Assigning Encryption Keys to Subsets

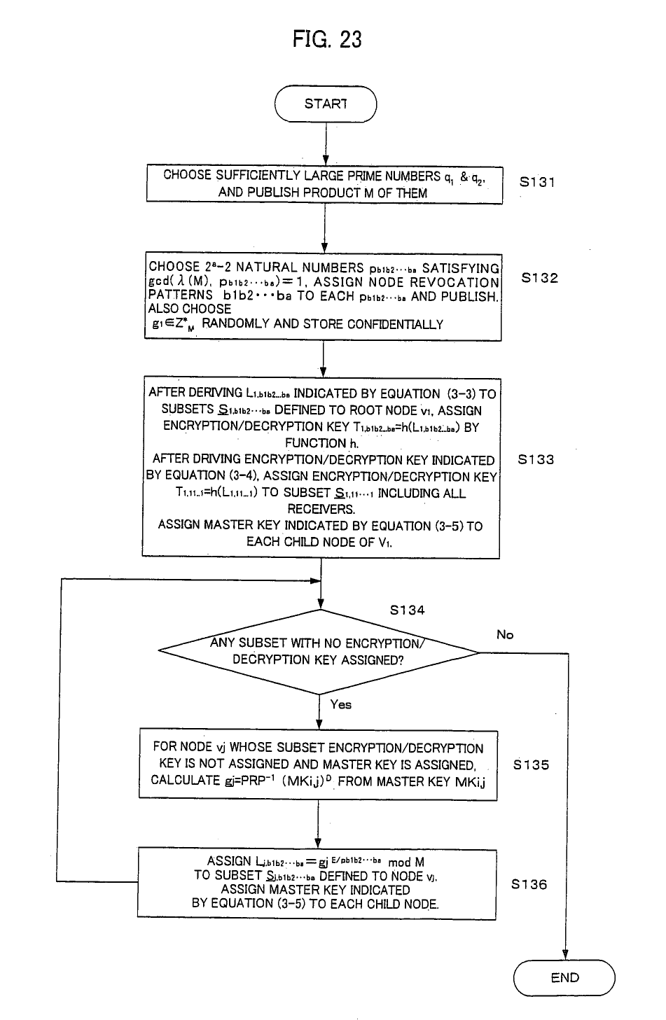

By referring to FIG. 23, the encryption key assigning process performed by the key management center, described in the second embodiment, will be described. The basic flow of the process is identical to the process describe with reference to FIG. 22.

The process of steps S131 and S132 are identical to the process of steps S121 and S122 in FIG. 22, and hence the description will be omitted.

In step S133, the key management center derives the encryption/decryption keys L_{1,b1b2 . . . ba} to be assigned to the 2^{a}−2 subsets S_{j,b1b2 . . . ba} defined to the root node vⱼ by the equation (3-3), and assigns the encryption/decryption keys T_{1,b1b2 . . . ba}=h(L_{1,b1b2 . . . ba}) by the function h. Specifically, the function h (indicated by the equation (3-17)) which converts the elements randomly distributed on Z*_{M} to arbitrary random number sequence of the length t is used. For the subset S_{1,11 . . . 1} including all the receivers, after deriving the encryption/decryption keys indicated by the equation (3-4), the encryption/decryption keys T_{1,11 . . . 1}=h(L_{1,11 . . . 1}) is assigned. At this time, the conversion is performed by using the function h. Also, the master keys MK_{1,j} indicated by the equation (3-5) are assigned to the child nodes vⱼ (j=2 . . . a+1) of v₁. Then, the process goes to step S134.

The flow of the process from step S134 to S136 is similar to the process from step S125 to S126 shown in FIG. 22. Namely, the key management center repeats the process of assigning the encryption/decryption keys until the encryption/decryption keys are assigned to all the subsets. However, in step S136, the conversion is performed by using the function h at the time of calculating the encryption/decryption keys T_{j,b1b2 . . . ba}. Then, the key management center assigns the master key indicated by the equation (3-5) to each node.

(3.4) Process Performed by Information Transmitter

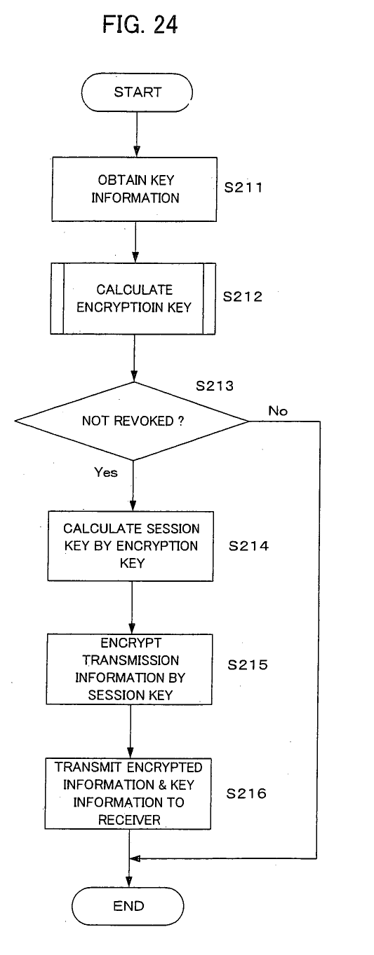

The outline of the contents encryption process performed by the information transmitter will be described with reference to FIG. 24. This process is performed by the contents recording apparatus 50 described above.

First, in step S211, the contents recording apparatus 50 obtains the key information from the key management center. The contents recording apparatus 50 may obtain the key information via a communication medium. If the contents recording apparatus 50 owns the key information in advance, the process of step S211 is not performed.

Next, the process of step S212 is performed when the information providing system is the system shown in FIG. 2 or FIG. 3. Therefore, the process of step S212 is not performed in the information providing system shown in FIG. 1. The contents recording apparatus 50 obtains the confidential information and the public information as well as the key information from the key management center (the public information can also be obtained from the public bulletin board), and calculates the encryption keys from them. If the information transmitter is revoked, the encryption key cannot be derived. However, the process goes out of this flow in S213 in that case, and hence there is no problem. The encryption keys can be derived by substituting the confidential information and the public information for the equation (3-6). If the key management system described in the second embodiment is adopted, the value calculated by the equation (3-6) is converted by the above-mentioned function h. When the above process is completed, the process goes to step S213.

In step S213, the contents recording apparatus 50 judges whether the information transmitter (contents recording apparatus 50) is not revoked. If the information receiver is revoked (step S213; No), the process goes out the flow and ends. The step S213 may be placed before step S212. In that case, the revoked information transmitters are excluded in advance, the encryption key is necessarily derived in step S212.

If the information transmitter is not revoked (step S213; Yes), the process goes to step S214. The contents recording apparatus 50 calculates the session key (i.e., information encryption key) by using the encryption key calculated in step S212. Then, the process goes to step S215.

In step S215, the contents recording apparatus 50 encrypts the transmission information by using the session key calculated in step S214 to produce encrypted information. Then, the process goes to step S216, and the contents recording apparatus 50 transmits the encrypted information and the key information to the information receiver.

(3.5) Process Performed by Information Receiver

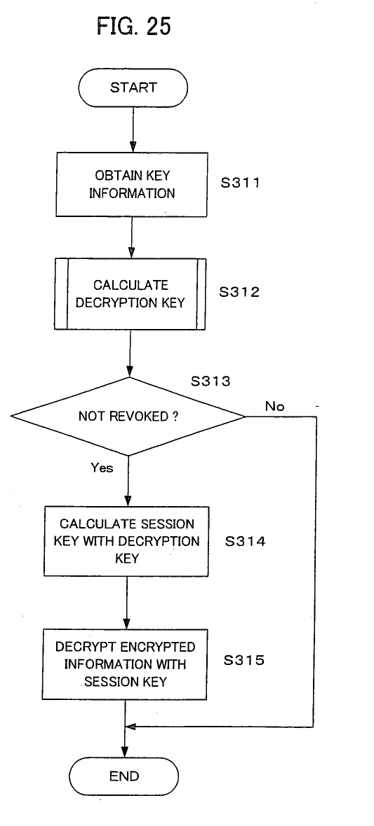

Next, the process performed by the information receiver will be described with reference to FIGS. 25 to 2. The information receiver may be the above-described contents playback apparatus 60, for example.

(3.5.1) Contents Decryption Process

The outline of the contents decryption process performed by the contents playback apparatus 60 will be described with reference to FIG. 25. The contents decryption process is a reverse process of the contents encryption process performed by the information transmitter, and is substantially the same process.

First, in step S311, the contents playback apparatus 60 obtains the encrypted information and the key information from the recording medium, such as an optical disc, on which the contents are recorded. The contents playback apparatus 60 may obtain them via a communication medium.

Next, in step S312, the contents playback apparatus 60 calculates the decryption keys by using the confidential information and the public information stored in the contents playback apparatus 60 and the obtained key information. If the information receiver is revoked, the decryption key cannot be derived. However, in that case, the process goes out of the flow in step S313, and hence there is no problem. In the case of the information providing system shown in FIG. 3, the contents playback apparatus 60 obtains the public information from the public bulletin board. The decryption key can be derived by substituting the confidential information and the public information for the equation (3-6). If the key management system described in the second embodiment is adopted, the value calculated by the equation (3-6) is converted by the above-mentioned function h. The detailed description of calculating the decryption key in step S312 will be omitted. When the above process is completed, the process goes to step S313.

In step S313, the contents playback apparatus 60 judges whether the contents playback apparatus 60 itself is not revoked. If the contents playback apparatus 60 is revoked (step S313; No), the process goes out of the flow and ends. Step S313 may be performed before step S312. In that case, the revoked information receivers are excluded in advance, the decryption key is necessarily derived in step S312.

If the contents playback apparatus 60 is not revoked (step S312; Yes), the process goes to step S314. The contents playback apparatus 60 calculates the session key (i.e., information decryption key) by using the decryption key calculated in step S312. Then, the process goes to step S315.

In step S315, the contents playback apparatus 60 decrypts the encrypted information by using the session key calculated in step S314 to produce received information. In this way, the contents playback apparatus 60 decrypts the encrypted information.

(3.5.2) Process of Calculating Decryption Key-I

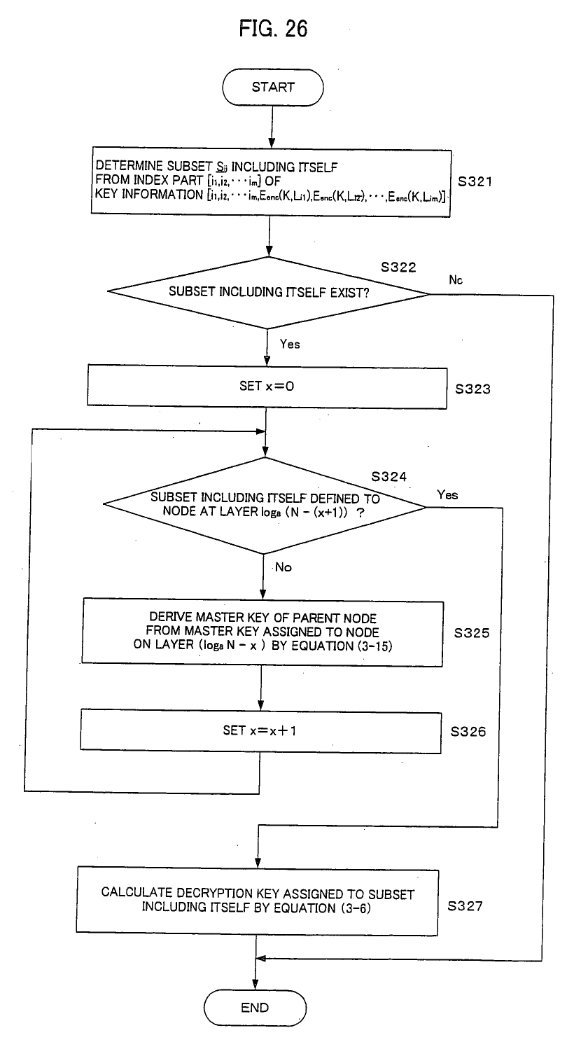

The process of calculating the decryption keys in step S312 in FIG. 25 will be specifically described with reference to FIG. 26. Although the calculation of the decryption keys in step S312 and the judgment whether or not the information receiver is revoked in step S313 are described as separate processes, those two processes will be described together. This process is performed by the contents play back apparatus 60. Also, this process derives the decryption keys defined by the key management system described in the first embodiment.

First, in step S321, the contents playback apparatus 60 judges the subset Sᵢⱼ to which the contents playback apparatus 60 itself is included, from the index part [i₁, i₂, . . . , iₘ] (i.e., the above-described header part) of the key information [i₁, i₂, . . . , iₘ, E_{enc}[K, Lᵢ₁], E_{enc}(K,Lᵢ₂), . . . , E_{enc}(K, Lᵢₘ)]. Then, the process goes to step S322.

In step S322, the contents playback apparatus 60 judges whether or not the subset to which the contents playback apparatus 60 itself belongs exists in the key information. Namely, the contents playback apparatus judges whether the contents playback apparatus 60 itself, is revoked or not with respect to the playback of the contents. If such subset does not exist (step S322; No), the process of calculating the decryption key ends.

On the other hand, if there exists the subset to which the contents playback apparatus 60 belongs (step S322; Yes), the process goes to step S323, and the contents playback apparatus 60 sets the counter x=0. This counter is stored in the memory in the contents playback apparatus 60. Then, the process goes to step S324.

In step S324, the contents playback apparatus 60 determines whether or not the subset to which the contents playback apparatus 60 itself belongs, determined in step S321, is defined to the node existing at the layer logₐN−(x+1). According to the key management system described in the first embodiment, the master keys are sequentially calculated from the lower layer to the upper layer, and the decryption keys are calculated by the master keys thus derived. Therefore, the calculation from the lower layer to the upper layer ends when the master key, with which the decryption key Lᵢⱼ assigned to the subset Sᵢⱼ determined in step S321 can be derived by the equation (3-6), is derived. Namely, in step S324, it is determined whether or not the master key, from which the decryption key used to the decryption of the key information according to the equation (3-6) can be derived, is obtained.

If the subsets to which the contents playback apparatus 60 itself belongs is not defined to the node existing at the layer logₐN−(x+1) (step S324; No), the process goes to step S325. The contents playback apparatus 60 derives, from the master key assigned to the node on the layer logaN-x, the master key of the parent node according to the equation (3-15). At this time, if x=0, the confidential information stored in the contents playback apparatus 60 is used as the master key. In order to calculate the decryption key, the obtained master key is stored in the memory in the contents playback apparatus 60. Then, the process goes to step S326.

In step S326, the contents playback apparatus 60 updates the counter x=x+1. Then, the process goes back to step S324, and the above process is repeated until the master key, with which the decryption key for decrypting the key information can be derived by the equation (3-6), is obtained.

If the subsets to which the contents playback apparatus 60 itself belongs is defined to the node existing at the layer logₐN−(x+1) (step S324; Yes), the process goes to step S327, wherein the decryption key assigned to the subset to which the contents playback apparatus 60 itself belongs is calculated by the equation (3-6). Thus, the contents playback apparatus 60 calculates the decryption key.

When the contents recording apparatus 50 calculates the encryption key (i.e., the process in step S212 in FIG. 24), the contents recording apparatus 50 can perform the same process as described in FIG. 26.

(3.5.3) Process of Calculating Decryption Key-II

The calculation process of the decryption keys defined by the key management system according to the second embodiment will be described, in a manner classified according to the implementation forms of the contents playback apparatus.

(A) Contents Playback Apparatus is PC Equipment

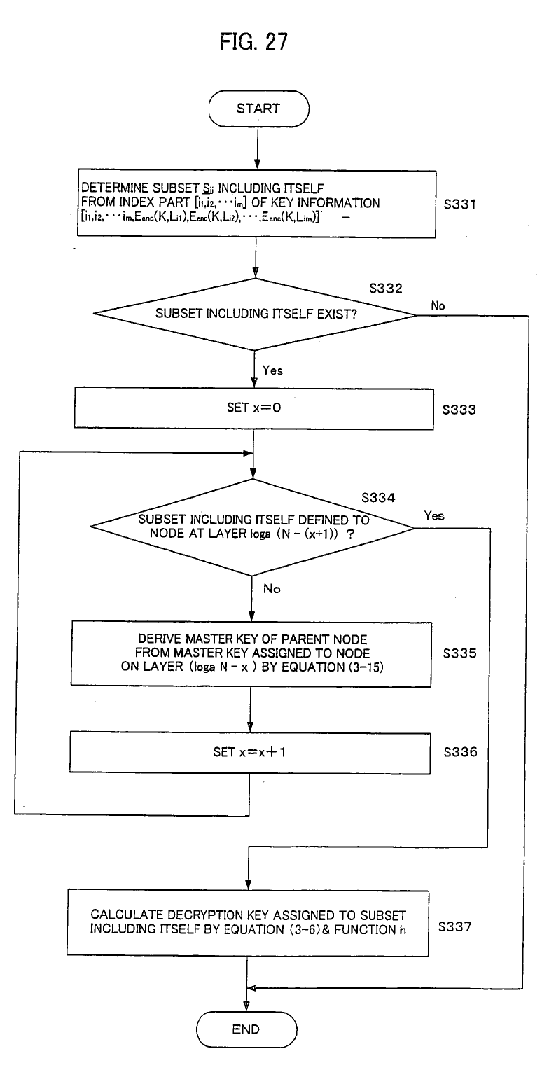

FIG. 27 shows the process of calculating the decryption keys by the contents playback apparatus 60 in the case that the contents playback apparatus 60 is a PC equipment and the key management system according to the first embodiment is chosen.

The contents playback apparatus 60 calculates the decryption keys defined by the key management system according to the first embodiment, and hence the process is basically the same as those shown in FIG. 26. Namely, the process of steps S331 to S336 shown in FIG. 27 is the same as the process of steps S321 to S326 shown in FIG. 26. However, in step S337, the contents playback apparatus 60 converts the value derived by the equation (3-6) using the function h, and the calculated value is determined as the decryption key.

(B) Contents Playback Apparatus is CE Equipment

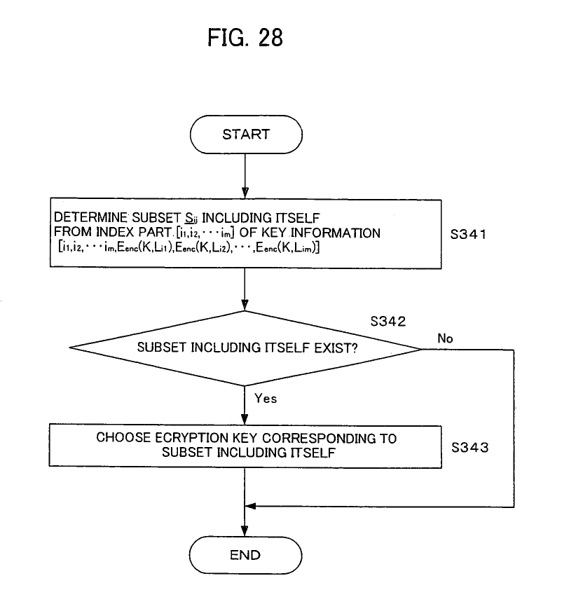

FIG. 28 shows the process of calculating the decryption keys by the contents playback apparatus 60 in the case that the contents playback apparatus 60 is a CE equipment and the key management system given in the first basic method (i.e., Complete Sub-tree Method etc.) is chosen.

First, in step S341, the contents playback apparatus 60 judges the subset to which the contents playback apparatus 60 itself is included, from the index part (i₁,i₂, . . . , iₘ] (i.e., the above-described header part) of the key information [i₁, i₂, . . . , iₘ, E_{enc}[K,Lᵢ₁], E_{enc}(K,Lᵢ₂), . . . , E_{enc}(K,Lᵢₘ)]. Then, the process goes to step S342.

In step S342, the contents playback apparatus 60 judges whether or not there exists the subset, to which the contents playback apparatus 60 itself belongs, in the key information. Namely, it is determined whether or not the contents playback apparatus 60 is revoked with respect to the playback of the contents. If the subset does not exist (step S342; No), the process calculating the decryption key ends.

If there exists the subset to which the contents playback apparatus 60 itself belongs (step S342; Yes), the process goes to step S343, and the contents playback apparatus chooses the decryption key corresponding to the subset to which the contents playback apparatus 60 itself belongs. In the case of the key management system described in the first basic method, the decryption key is directly stored in the playback apparatus, and hence the calculation is not needed. In this way, the contents playback apparatus can obtain the decryption key.

### INDUSTRIAL APPLICABILITY

The key management system according to the present invention is applicable to various products, such as a DVD player, a DVD recorder, a PDP, a portable music player and a PC, which handles copyright contents via a certain communication medium such as an optical disc or a network.

The invention may be embodied on other specific forms without departing from the spirit or essential characteristics thereof. The present embodiments therefore to be considered in all respects as illustrative and not restrictive, the scope of the invention being indicated by the appended claims rather than by the foregoing description and all changes which come within the meaning an range of equivalency of the claims are therefore intended to embraced therein.

The entire disclosure of Japanese Patent Application No. 2004-147992 filed on May 18, 2004 including the specification, claims, drawings and summary is incorporated herein by reference in its entirety.

1. A key management apparatus for generating key information in association with a tree structure which has at least one root node and in which plural nodes are assigned under a node as leaves, comprising;
a composite number operating unit which calculates a composite number which is a product of more than one arbitrary prime numbers;
a first confidential information storage unit which stores an arbitrary natural number which is smaller than the composite number and is relatively prime to the composite number, as first confidential information, in association with the root node;
a public information storage unit which stores natural numbers, which are relatively prime to each other in a subset expressed by a combination of plural child nodes of an arbitrary node in the tree structure, as public information in association with the subset;
a first master key operating unit which calculates master keys corresponding to the child nodes of the root node based on the first confidential information assigned to the root node and the public information;
a first master key storage unit which stores the master keys in association with the corresponding child nodes;
a second confidential information operating unit which calculates, for each node, second confidential information, by a bijective function based on the master keys set to parent node having the node as the child node and the composite number;
a second confidential information storage unit which stores the second confidential information in association with the corresponding arbitrary node;
a second master key operating unit which calculates the master keys corresponding to the child nodes of each of the nodes based on the second confidential information assigned to each of the nodes and the public information;
a second master key storage unit which stores the master keys in association with the corresponding child nodes;
an encryption/decryption key operating unit which calculates encryption/decryption keys, for the subset, based on the first confidential information or the second confidential information assigned to the node and the public information; and
an encryption/decryption key storage unit which stores the encryption/decryption keys in association with the nodes.

2. A playback apparatus comprising:
a unit which obtains a composite number generated by a key management apparatus, public information, and confidential information assigned to leaves corresponding to playback apparatuses;
a unit which obtains key information generated by the key management apparatus;
a unit which obtains encrypted contents encrypted with an encryption key generated by the key management apparatus;
a unit which determines whether or not a subset to which the playback apparatus itself belongs, exists from the key information;
a third master key operating unit which calculates master keys corresponding to nodes existing on a path from the leaf to a root node by a bijective function, based on the confidential information assigned to the leaf corresponding to the playback apparatus, the composite number and the public information;
a second master key storage unit which stores the master keys in association with the corresponding leaves;
a decryption key operating unit which calculates decryption key, for the subset to which the playback apparatus belongs, based on the master keys, the composite number and the public information;
a unit which decrypts the encrypted contents with the decryption key; and
a unit which plays decrypted contents.

3. A recording medium carrying: key information encrypted with encryption key generated by a key management unit;
and encrypted contents encrypted by the key information, wherein the key management unit comprises:
a composite number operating unit which calculates a composite number which is a product of more than one arbitrary prime numbers;
a first confidential information storage unit which stores an arbitrary natural number which is smaller than the composite number and is relatively prime to the synthesizing number, as first confidential information, in association with the root node;
a public information storage unit which stores natural numbers, which are relatively prime to each other in a subset expressed by a combination of plural child nodes of an arbitrary node in the tree structure, as public information in association with the subset;
a first master key operating unit which calculates master keys corresponding to the child nodes of the root node based on the first confidential information assigned to the root node and the public information;
a first master key storage unit which stores the master keys in association with the corresponding child nodes;
a second confidential information operating unit which calculates, for each node, second confidential information by a bijective function based on the master key assigned to parent node having the node as the child node and the composite number;
a second confidential information storage unit which stores the second confidential information in association with the corresponding arbitrary node;
a second master key operating unit which calculates the master keys corresponding to the child nodes of each of the nodes based on the second confidential information assigned to each of the nodes and the public information;
a second master key storage unit which stores the master keys in association with the corresponding child nodes;
an encryption/decryption key operating unit which calculates encryption/decryption keys, for the subset, based on the first confidential information or the second confidential information assigned to the node and the public information; and
an encryption/decryption key storage unit which stores the encryption/decryption keys in association with the nodes.

4. A key management system comprising a key management apparatus, a recording apparatus and a playback apparatus,
wherein the key management apparatus comprises:
a composite number operating unit which calculates a composite number which is a product of more than one arbitrary prime numbers;
a first confidential information storage unit which stores an arbitrary natural number which is smaller than the composite number and is relatively prime to the composite number, as first confidential information, in association with the root node;
a public information storage unit which stores natural numbers, which are prime relative to each other in a subset expressed by a combination of plural child nodes of an arbitrary node in the tree structure, as public information in association with the subset;
a first master key operating unit which calculates master keys corresponding to the child nodes of the root node based on the first confidential information assigned to the root node and the public information;
a first master key storage unit which stores the master keys in association with the corresponding child nodes;
a second confidential information operating unit which calculates, for each node, second confidential information, by a bijective function based on the master key assigned to parent nodes having the node as the child node and the composite number,
a second confidential information storage unit which stores the second confidential information in association with the corresponding arbitrary node;
a second master key operating unit which calculates the master keys corresponding to the child nodes of each of the nodes based on the second confidential information assigned to each of the nodes and the public information;
a second master key storage unit which stores the master keys in association with the corresponding child nodes;
an encryption/decryption key operating unit which calculates encryption/decryption keys, for the subset, based on the first confidential information or the second confidential information assigned to the node and the public information;
an encryption/decryption key storage unit which stores the encryption/decryption keys in association with the nodes;
a unit which supplies the key information and the encryption key to the recording apparatus; and
a unit which supplies the public information and the confidential information to the playback apparatus,
wherein the recording apparatus comprises:
a unit which obtains the encryption key generated by the key management apparatus;
a unit which generates encrypted contents by encrypting contents with the encryption key; and
a unit which records the encrypted contents on a recording medium,
wherein the playback apparatus comprising:
a unit which obtains the composite number, the public information and confidential information assigned to the leaf corresponding to the playback apparatus from the key management apparatus;
a unit which obtains the key information generated by the key management apparatus and the encrypted contents from the recording medium;
a unit which determines whether or not a subset to which the playback apparatus itself belongs, exists from the key information;
a third master key operating unit which calculates master keys corresponding to nodes existing on a path from the leaf to a root node by a bijective function, based on the confidential information assigned to the leaf corresponding to the playback apparatus, the composite number and the public information;
a second master key storage unit which stores the master keys in association with the corresponding leaves;
a decryption key operating unit which calculates decryption key, for the subset to which the playback apparatus belongs, based on the master keys, the composite number and the public information;
a unit which decrypts the encrypted contents with the decryption key; and
a unit which plays decrypted contents.

5. A key management method for generating key information in association with a tree structure which has at least one root node and in which plural nodes are assigned under the node as leaves, comprising:
a composite number operating process which calculates a composite number which is a product of more than one arbitrary prime numbers;
a first confidential information storage process which stores an arbitrary natural number which is smaller than the composite number and is relatively prime to the composite number, as first confidential information, in association with the root node;
a public information storage process which stores natural numbers, which are relatively prime to each other in a subset expressed by a combination of plural child nodes of an arbitrary node in the tree structure, as public information in association with the subset;
a first master key operating process which calculates master keys corresponding to the child nodes of the root node based on the first confidential information assigned to the root node and the public information;
a first master key storage process which stores the master keys in association with the corresponding child nodes;
a second confidential information operating process which calculates, for each node, second confidential information, by a bijective function based on the master key assigned to parent node having the node as the child node and the composite number;
a second confidential information storage process which stores the second confidential information in association with the corresponding arbitrary node;
a second master key operating process which calculates the master keys corresponding to the child nodes of each of the nodes based on the second confidential information assigned to each of the nodes and the public information;
a second master key storage process which stores the master keys in association with the corresponding child nodes;
an encryption/decryption key operating process which calculates encryption/decryption keys, for the subset, based on the first confidential information or the second confidential information set to the node and the public information; and
an encryption/decryption key storage process which stores the encryption/decryption keys in association with the nodes.

6. A key management program product executed on a computer, the program product allows the computer to function as a key management apparatus for generating key information in association with a tree structure which has at least one root node and in which plural nodes are assigned under the node as leaves, the key management apparatus comprising:
a composite number operating unit which calculates a composite number which is a product of more than one arbitrary prime numbers:
a first confidential information storage unit which stores an arbitrary natural number which is smaller than the composite number and is relatively prime to the composite number, as first confidential information, in association with the root node;
a public information storage unit which stores natural numbers, which are relatively prime to each other in a subset expressed by a combination of plural child nodes of an arbitrary node in the tree structure, as public information in association with the subset;
a first master key operating unit which calculates master keys corresponding to the child nodes of the root node based on the first confidential information assigned to the root node and the public information;
a first master key storage unit which stores the master keys in association with the corresponding child nodes;
a second confidential information operating unit which calculates, for each node, second confidential information, by a bijective function based on the master key assigned to parent node having the node as the child node and the composite number;
a second confidential information storage unit which stores the second confidential information in association with the corresponding arbitrary node;
a second master key operating unit which calculates the master keys corresponding to the child nodes of each of the nodes based on the second confidential information assigned to each of the nodes and the public information;
a second master key storage unit which stores the master keys in association with the corresponding child nodes;
an encryption/decryption key operating unit which calculates encryption/decryption keys, for the subset, based on the first confidential information or the second confidential information assigned to the node and the public information; and
an encryption/decryption key storage unit which stores the encryption/decryption keys in association with the nodes.

7. A playback apparatus method comprising:
a process which obtains a composite number generated by a key management apparatus, public information, and confidential information assigned to leaves corresponding to playback apparatuses;
a process which obtains key information generated by the key management apparatus;
a process which obtains encrypted contents encrypted with an encryption key generated by the key management apparatus;
a process which determines whether or not a subset to which the playback apparatus itself belongs, exists from the key information;
a third master key operating process which calculates master keys corresponding to nodes existing on a path from the leaves to a root node by a bijective function, based on the confidential information assigned to the leaf corresponding to the playback apparatus, the composite number and the public information;
a second master key storage process which stores the master keys in association with the corresponding leaves;
a decryption key operating process which calculates decryption key, for the subset to which the playback apparatus belongs, based on the master keys, the composite number and the public information;
a process which decrypts the encrypted contents with the decryption key; and
a process which plays decrypted contents.

8. A playback program product executed on a computer, the program product allows the computer to function as a playback apparatus comprising:
a unit which obtains a composite number generated by a key management apparatus, public information, and confidential information assigned to leaves corresponding to playback apparatuses;
a unit which obtains key information generated by the key management apparatus;
a unit which obtains encrypted contents encrypted with an encryption key generated by the key management apparatus;
a unit which determines whether or not a subset to which the playback apparatus itself belongs exists from the key information;
a third master key operating unit which calculates master keys corresponding to nodes existing on a path from the leaves to a root node by a bijective function, based on the confidential information assigned to the leaf corresponding to the playback apparatus, the composite number and the public information;
a second master key storage unit which stores the master keys in association with the corresponding leaves;
a decryption key operating unit which calculates decryption key, for the subset to which the playback apparatus belongs, based on the master keys, the composite number and the public information;
a unit which decrypts the encrypted contents with the decryption key; and
a unit which plays decrypted contents.
